(19) United States
(12) Patent Application Publication
(10) Pub. No.: US 2026/0145141 A1
(43) Pub. Date: May 28, 2026

(54) SEPARATION SYSTEMS FOR SEPARATING COMPONENTS OF AN EXTRACT SUSPENDED WITHIN A SOLVENT AND RELATED METHODS

(71) Applicants: Valor Equipment LLC, dba SciPhy Systems, Gladstone, OR (US); Molecular Forces Consulting LLC, Portland, OR (US)

(72) Inventors: John Mark Herring, Portland, OR (US); Zev Feinstein, Portland, OR (US); Emmett McGregor, Portland, OR (US)

(21) Appl. No.: 19/398,682

(22) Filed: Nov. 24, 2025

Related U.S. Application Data
(60) Provisional application No. 63/723,827, filed on Nov. 22, 2024.

(51) Int. Cl. B01D 69/02; B01D 61/02; B01D 61/14; B01D 71/02; B01D 71/70

(52) U.S. Cl. CPC B01D 69/02; B01D 61/027; B01D 61/145; B01D 71/02; B01D 71/701; B01D 2313/24; B01D 2325/02831; B01D 2325/02832; B01D 2325/02833; B01D 2325/02834; B01D 2325/38

(57) ABSTRACT

Separation systems for separating components of an extract suspended within a solvent and related methods. The separation system includes a feed zone, a pressurization device, a high-pressure zone, a filter assembly, and a permeate zone. The feed zone is configured to receive a feed stream that includes an extract suspended within a solvent. The pressurization device is configured to pressurize the feed stream to define a pressurized feed stream. The high-pressure zone is configured to receive the pressurized feed stream. The filter assembly includes a filter element configured to receive the pressurized feed stream and to separate the pressurized feed stream into a permeate stream and a retentate stream. The permeate zone is configured to receive the permeate stream from the filter assembly. The methods include methods of utilizing the separation systems.

### RELATED APPLICATION

This application claims priority to U.S. Provisional Ser. No. 63/723,827, which was filed on Nov. 22, 2024, and the complete disclosure of which is hereby incorporated by reference.

### FIELD OF THE DISCLOSURE

The present disclosure relates generally to separation systems for separating components of an extract suspended within a solvent and to related methods.

### BACKGROUND OF THE DISCLOSURE

Extracts, such as botanical extracts, fungal extracts, animal product extracts, and/or extracts from cannabis plants, often contain a plurality of compounds and/or components. In certain circumstances, it may be desirable to separate one or more compounds and/or components that are contained within the extract from one or more other components contained therein. As an example, it may be desirable to separate cannabinoids, which are contained within a cannabis extract, from one or more other naturally occurring components that also are contained within the cannabis extract. Conventionally, distillation and/or chromatography processes have been utilized to accomplish this separation. While such conventional separation processes are effective under certain circumstances, they often require costly equipment, are quite energy-intensive, and/or waste a significant fraction of desirable components of the extracts. Thus, there exists a need for improved separation systems for separating components of a extract suspended within a solvent and related methods.

### SUMMARY OF THE DISCLOSURE

Separation systems for separating components of an extract suspended within a solvent and related methods. The extract includes at least one of a botanical extract, a fungal extract, and an animal product extract. The solvent is in a solvent gas phase at standard temperature and pressure, and the separation system is configured to maintain the solvent in at least one of a solvent liquid phase and a solvent supercritical phase. The separation system includes a feed zone, a pressurization device, a high-pressure zone, a filter assembly, and a permeate zone. The feed zone is configured to receive a feed stream that includes the extract suspended within the solvent and to maintain the feed stream at a feed zone temperature and a feed zone pressure. The pressurization device is configured to pressurize the feed stream to define a pressurized feed stream. The high-pressure zone is configured to receive the pressurized feed stream and to maintain the pressurized feed stream at a high-pressure zone temperature and a high-pressure zone pressure. The filter assembly includes a filter element configured to receive the pressurized feed stream and to separate the pressurized feed stream into a permeate stream, which includes a permeate fraction of the solvent and a permeate fraction of the extract that passes through the filter element, and a retentate stream, which includes a retentate fraction of the solvent and a retentate fraction of the extract that does not pass through the filter element. The permeate zone is configured to receive the permeate stream from the filter assembly and to maintain the permeate stream at least one of at a permeate zone temperature and at a permeate zone pressure. The methods include methods of utilizing the separation systems.

### BRIEF DESCRIPTION OF THE DRAWINGS

FIG. 1 is a schematic illustration of examples of separation systems according to the present disclosure.

FIG. 2 is another schematic illustration of examples of separation systems according to the present disclosure.

FIG. 3 is another schematic illustration of examples of separation systems according to the present disclosure.

FIG. 4 is a less schematic profile view illustrating an example of a separation system according to the present disclosure.

FIG. 5 is another less schematic profile view of the separation system of FIG. 4.

FIG. 6 is a flowchart illustrating examples of methods of separating components of an extract suspended within a solvent utilizing separation systems, according to the present disclosure.

### DETAILED DESCRIPTION AND BEST MODE OF THE DISCLOSURE

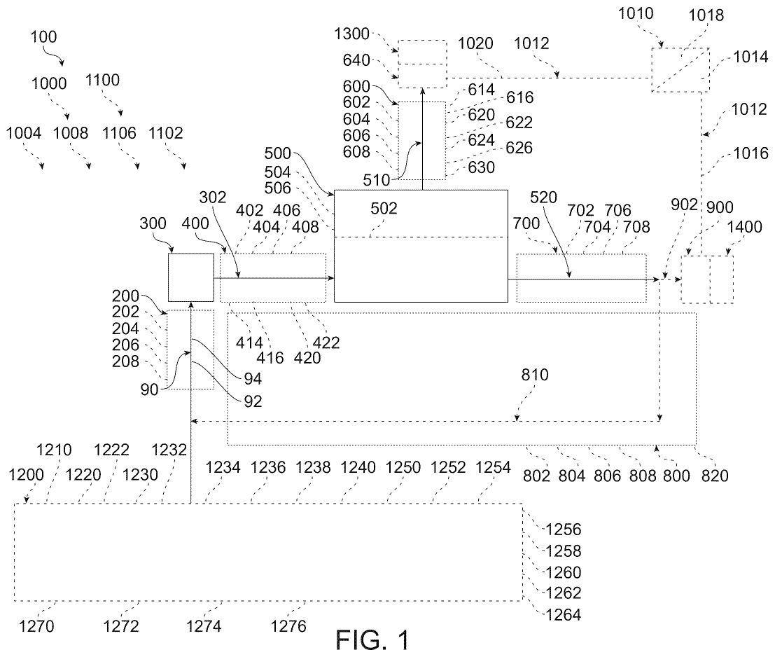

FIGS. 1-6 provide examples of separation systems 100 and/or of methods 1500, according to the present disclosure. Elements that serve a similar, or at least substantially similar, purpose are labeled with like numbers in each of FIGS. 1-6, and these elements may not be discussed in detail herein with reference to each of FIGS. 1-6. Similarly, all elements may not be labeled in each of FIGS. 1-6, but reference numerals associated therewith may be utilized herein for consistency. Elements, components, and/or features that are discussed herein with reference to one or more of FIGS. 1-6 may be included in and/or utilized with any of FIGS. 1-6 without departing from the scope of the present disclosure.

In general, elements that are likely to be included in a particular embodiment are illustrated in solid lines, while elements that may be optional are illustrated in dashed lines. However, elements that are shown in solid lines may not be essential to all embodiments and, in some embodiments, may be omitted without departing from the scope of the present disclosure.

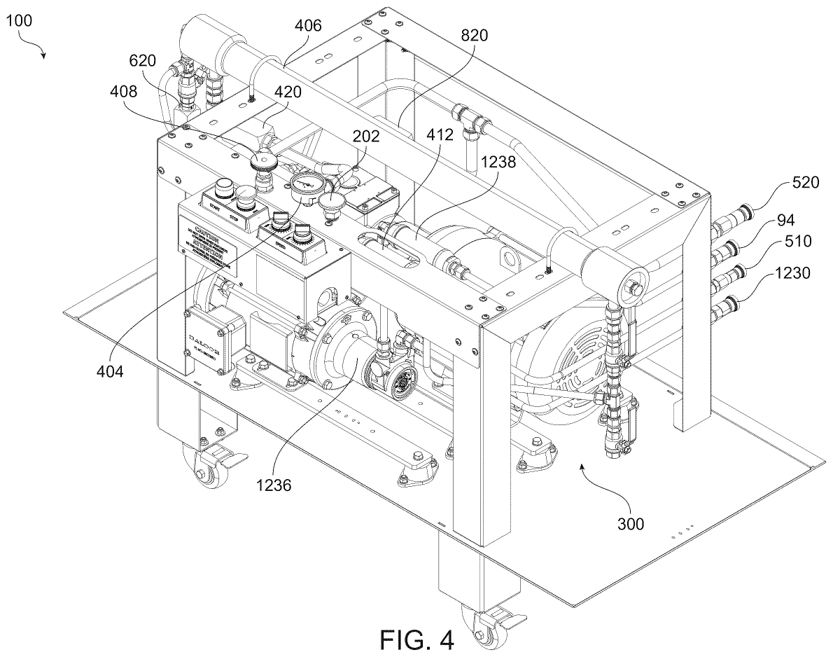

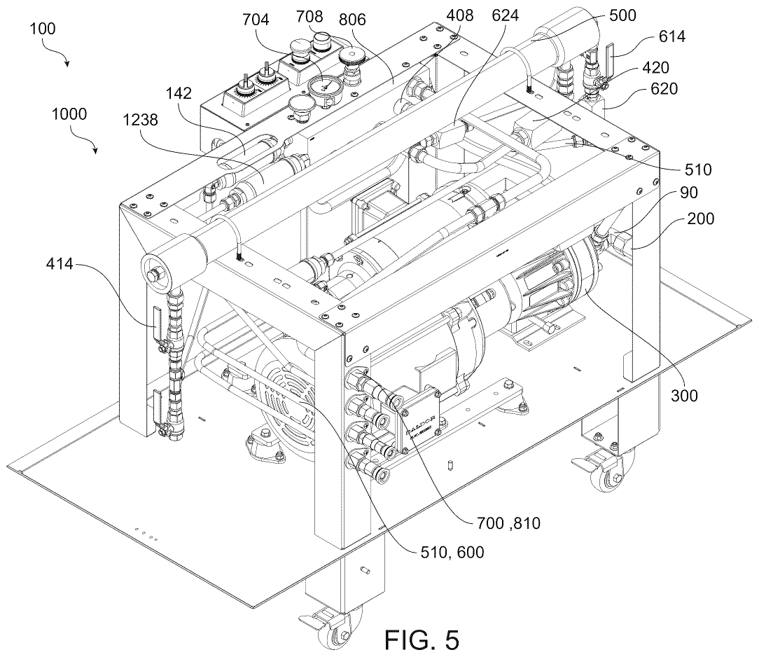

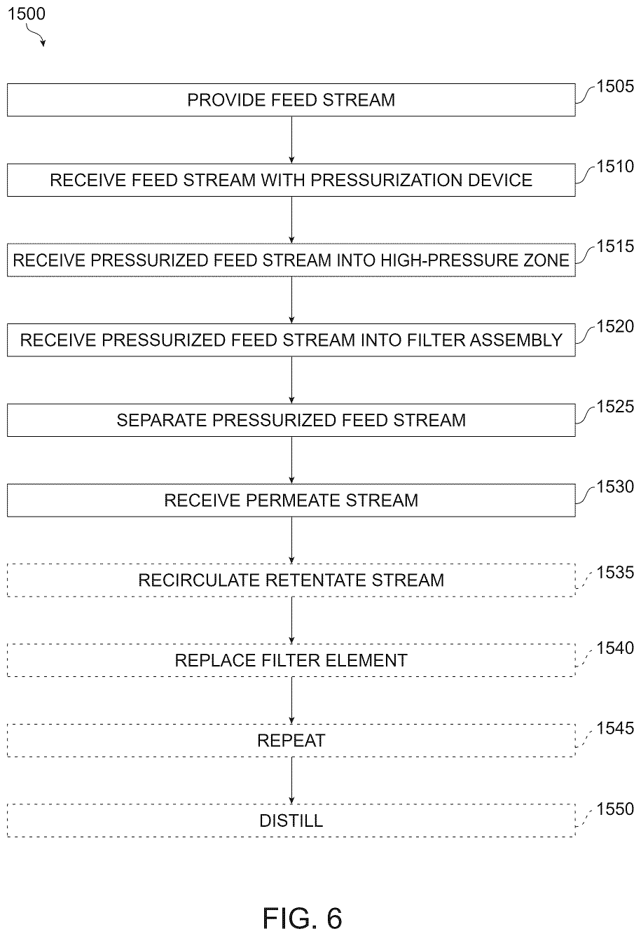

FIGS. 1-3 are schematic illustrations of examples of separation systems 100 according to the present disclosure. FIGS. 4-5 are less schematic profile views illustrating an example of a separation system 100 according to the present disclosure, and FIG. 6 is a flow chart illustrating examples of methods 1500 of separating components of an extract according to the present disclosure, such as via use of separation systems 100.

Separation systems 100 are configured to separate components of an extract 92 contained within a solvent 94, examples of which are disclosed herein. At standard temperature and pressure (STP), or 0 degrees Celsius and 101.3 kilopascals, solvent 94 may be in, or may exist in, a solvent gas phase. Stated differently, the solvent may be gaseous and/or is in a gas phase at STP. However, separation systems 100 may be configured to maintain the solvent within a solvent liquid phase and/or within a solvent supercritical phase therewithin. Stated differently, the solvent may always be a liquid and/or a supercritical fluid within separation systems 100 and/or within at least a region of separation systems 100. As examples, the solvent always may be the liquid and/or the supercritical fluid within, within at least a region of, and/or within an entirety of a high-pressure zone 400, a filter assembly 500, a permeate zone 600, and/or a retentate zone 700 thereof. Stated still differently, a vapor pressure of the solvent may be greater than 101.3 kilopascals at 0 degrees Celsius, or a critical point temperature of the solvent is less than 0 degrees Celsius.

However, and as discussed in more detail herein, separation systems 100 may control and/or regulate temperature and/or pressure therein such that the solvent is maintained within the solvent liquid phase and/or within the solvent supercritical phase within the separation systems. In other words, separation systems 100 may be configured to avoid vaporization and/or cavitation of solvent 94 therewithin, as such vaporization and/or cavitation may be detrimental to one or more components of the separation system, may cause extract 92 to cease being suspended within the solvent, and/or may decrease an overall efficiency of separations performed by and/or within the separation systems.

As collectively illustrated by FIGS. 1-5, and with specific reference to FIGS. 1-3, separation systems 100 include a feed zone 200, a pressurization device 300, high-pressure zone 400, filter assembly 500, and permeate zone 600. Feed zone 200 is configured to receive a feed stream 90 that includes extract 92 suspended within solvent 94. Feed zone 200 additionally or alternatively may be configured to maintain feed stream 90 at a feed zone temperature and a feed zone pressure, examples of which are disclosed herein. The feed zone temperature and the feed zone pressure are such that the solvent is maintained in the solvent liquid phase and/or in the solvent supercritical phase within the feed zone. Pressurization device 300 is configured to receive the feed stream from the feed zone and/or to pressurize the feed stream to produce and/or generate a pressurized feed stream 302.

High-pressure zone 400 is configured to receive pressurized feed stream 302, such as from pressurization device 300, and/or to maintain the pressurized feed stream at a high-pressure zone temperature and a high-pressure zone pressure, examples of which are disclosed herein. The high-pressure zone temperature and the high-pressure zone pressure are such that the solvent is maintained in the solvent liquid phase and/or in the solvent supercritical phase within the high-pressure zone.

Filter assembly 500 includes a filter element 502 that is configured to receive pressurized feed stream 302, such as from high-pressure zone 400, and to separate the pressurized feed stream into a permeate stream 510 and a retentate stream 520. Permeate stream 510 includes a permeate fraction of solvent 94 and also may include a permeate fraction of extract 92, both of which pass through filter element 502. Retentate stream 520 includes a retentate fraction of solvent 94 and also may include a retentate fraction of extract 92, both of which do not pass through the filter element.

Permeate zone 600 is configured to receive permeate stream 510, such as from filter assembly 500, and/or to maintain the permeate stream at a permeate zone temperature and/or at a permeate zone pressure, examples of which are disclosed herein. The permeate zone temperature and the permeate zone pressure are such that the solvent is maintained within the solvent liquid phase and/or in the solvent supercritical phase within the permeate zone.

During operation of separation systems 100 and as is discussed in more detail herein with reference to methods 1500 of FIG. 6, feed stream 90 may be provided to feed zone 200, which may provide the feed stream to pressurization device 300. The pressurization device may receive the feed stream and/or may pressurize the feed stream to produce and/or generate pressurized feed stream 302. High-pressure zone 400 may receive the pressurized feed stream from the pressurization device and may provide the pressurized feed stream to filter assembly 500. Filter assembly 500 may receive the pressurized feed stream and may separate the pressurized feed stream into permeate stream 510 and retentate stream 520 utilizing filter element 502. The permeate stream then may be provided to permeate zone 600. As discussed in more detail herein, feed zone 200, pressurization device 300, high-pressure zone 400, filter assembly 500, and/or permeate zone 600 all may be configured such that solvent 94 within feed stream 90 is maintained in the solvent liquid phase and/or in the solvent supercritical phase therewithin, such as via control, regulation, and/or maintenance of various temperatures and/or pressures within these structures, regions, and/or zones of the separation system.

Feed zone 200 may include any suitable structure that may be adapted, configured, designed, and/or constructed to receive feed stream 90, to maintain the feed stream at the feed zone temperature, to maintain the feed stream at the feed zone pressure, and/or to provide the feed stream to pressurization device 300. As examples, feed zone 200 may include any suitable feed zone fluid conduit, feed zone pipe, feed zone fitting, and/or feed zone valve. As additional examples, feed zone 200 may include a feed zone temperature sensor 202, a feed zone pressure sensor 204, a feed zone temperature regulation device 206, and/or a feed zone pressure regulation device 208, as illustrated in FIG. 1. Feed zone temperature sensor 202 and/or feed zone temperature regulation device 206 may form a portion of a temperature regulation system 1100 of separation system 100, examples of which are discussed in more detail herein. Additionally or alternatively, feed zone pressure sensor 204 and/or feed zone pressure regulation device 208 may form a portion of a pressure regulation system 1000 of separation system 100, examples of which are discussed in more detail herein.

The feed zone temperature may include and/or be any suitable temperature that maintains the solvent in the solvent liquid phase and/or in the solvent supercritical phase within the feed zone when the solvent is at the feed zone pressure. As an example, the feed zone temperature may be less than a thermal degradation temperature of one or more thermally unstable components of the extract within the feed zone. The selected, or designed-for, component associated with the thermal degradation temperature may be or include the most thermally unstable component of the extract, but it is within the scope of the disclosure that the feed zone temperature may be selected based on a thermal degradation temperature of any component(s) in the extract. As another example, the feed zone temperature may be less than an autoignition temperature of the solvent within the feed zone. More specific examples of the feed zone temperature include temperatures of at least-150 degrees Celsius (° C.) , at least −140° C., at least −130° C., at least −120° C., at least −110° C., at least −100° C., at least −90° C., at least −80° C., at least −70° C., at least −60° C., at least −50° C., at least −40° C., at least −30° C., at least −20° C., at least −10° C., at least 0° C., at least 10° C., at least 20° C., at least 30° C., at least 40° C., at least 50° C., at most 100° C., at most 90° C., at most 80° C., at most 70° C., at most 60° C., at most 50° C., at most 40° C., at most 30° C., at most 20° C., at most 10° C., at most 0° C., at most −10° C., at most −20° C., at most −30° C., at most −40° C., at most −50° C., at most −60° C., at most −70° C., at most −80° C., at most −90° C., at most −99° C., and/or at most −100° C..

Similarly, the feed zone pressure may include and/or be any suitable pressure that maintains the solvent within the solvent liquid phase and/or within the solvent supercritical phase within the feed zone when the solvent is at the feed zone temperature. As an example, the feed zone pressure may be greater than a feed zone solvent vapor pressure of the solvent at the feed zone temperature. As another example, the feed zone pressure may be at least a threshold feed zone pressure differential greater than the feed zone solvent vapor pressure. Examples of the threshold feed zone pressure differential include at least 5 kilopascals (kPa), at least 10 kPa, at least 20 kPa, at least 30 kPa, at least 40 kPa, at least 50 kPa, at least 75 kPa, at least 100 kPa, at least 150 kPa, at least 200 kPa, at least 500 kPa, at least 750 kPa, at least 1 megapascal (MPa), at least 5 MPa, at least 10 MPa, at least 15 MPa, at least 20 MPa, at most 30 MPa, at most 25 MPa, at most 20 MPa, at most 15 MPa, at most 10 MPa, at most 5 MPa, at most 1 MPa, at most 900 kPa, at most 700 kPa, at most 600 kPa, at most 500 kPa, at most 400 kPa, at most 300 kPa, at most 200 kPa, at most 100 kPa, at most 50 kPa, at most 40 kPa, at most 30 kPa, at most 20 kPa, at most 10 kPa, at most 9 kPa, at most 8 kPa, at most 7 kPa, at most 6 kPa, and/or at most 5 kPa.

Pressurization device 300 may include any suitable structure that may be adapted, configured, designed, and/or constructed to pressurize feed stream 90, such as to define pressurized feed stream 302. Examples of pressurization device 300 include a pump, a positive displacement pump, a pressure exchange device, and/or a centrifugal pump. Pressurization device 300 may be configured to generate a pressurization device pressure differential between the feed stream and the pressurized feed stream. The pressurization device pressure differential may be at least as large as a pressure differential between the high-pressure zone pressure and the feed zone pressure. Additionally or alternatively, the pressurization device may be utilized to generate the pressure differential between the high-pressure zone pressure and the feed zone pressure. Examples of the pressurization device pressure differential may be at least 5 kPa, at least 10 kPa, at least 20 kPa, at least 30 kPa, at least 40 kPa, at least 50 kPa, at least 100 kPa, at least 150 kPa, at least 200 kPa, at least 400 kPa, at least 600 kPa, at least 800 kPa, at least 1 MPa, at least 2 MPa, at least 3 MPa, at least 4 MPa, at least 5 MPa, at most 7 MPa, at most 6 MPa, at most 5 MPa, at most 4 MPa, at most 3 MPa, at most 2 MPa, at most 1 MPa, at most 500 kPa, at most 400 kPa, at most 300 kPa, at most 200 kPa, at most 100 kPa, at most 50 kPa, at most 40 kPa, at most 30 kPa, at most 20 kPa, at most 10 kPa, at most 9 kPa, at most 8 kPa, at most 7 kPa, at most 6 kPa, and/or at most 5 kPa.

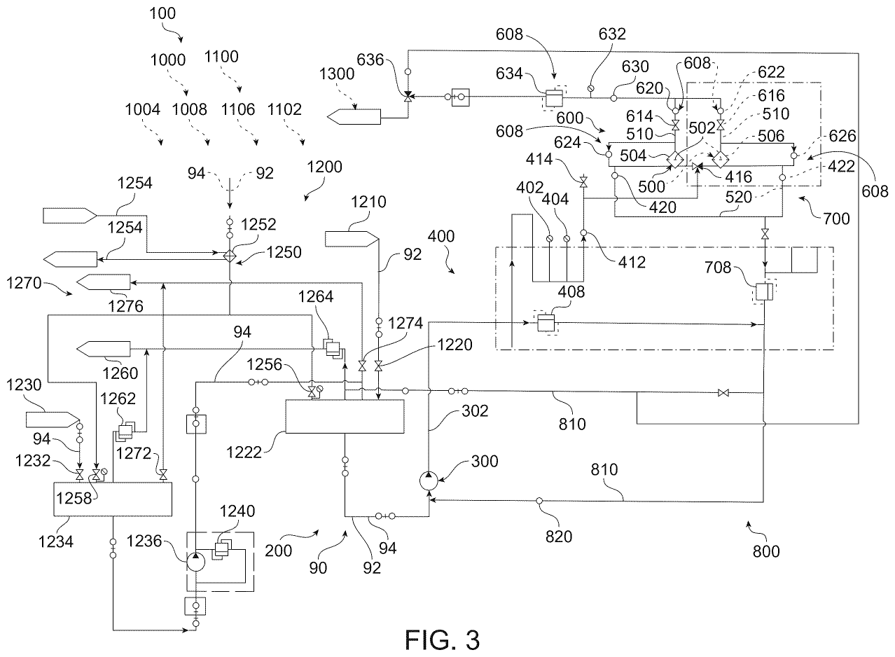

High-pressure zone 400 may include any suitable structure that may be adapted, configured, designed, and/or constructed to receive pressurized feed stream 302, such as from pressurization device 300, to maintain the pressurized feed stream at the high-pressure zone temperature, to maintain the pressurized feed stream at the high-pressure zone pressure, and/or to provide the pressurized feed stream to filter assembly 500. As examples, high-pressure zone 400 may include any suitable high-pressure zone fluid conduit, high-pressure zone pipe, high-pressure zone fitting, and/or high-pressure zone valve. As additional examples, high-pressure zone 400 may include a high-pressure zone temperature sensor 402, a high-pressure zone pressure sensor 404, and/or a high-pressure zone temperature regulation device 406, as illustrated in FIG. 1. Additionally or alternatively, the high-pressure zone may include a high-pressure zone pressure regulation device 408, as illustrated in FIGS. 1 and 3. High-pressure zone temperature sensor 402 and/or high-pressure zone temperature regulation device 406 may form a portion of temperature regulation system 1100. Additionally or alternatively, high-pressure zone pressure sensor 404 and/or high-pressure zone pressure regulation device 408 may form a portion of pressure regulation system 1000 of separation system 100, examples of which are discussed in more detail herein.

The high-pressure zone temperature may include and/or be any suitable temperature that maintains the solvent in the solvent liquid phase and/or in the solvent supercritical phase within the high-pressure zone when the solvent is at the high-pressure zone pressure. As an example, the high-pressure zone temperature may be less than the thermal degradation temperature of the thermally unstable, or the most thermally unstable, component of the extract within the high-pressure zone. The selected, or designed-for, component associated with the high-pressure zone temperature may be or include the most thermally unstable component of the extract, but it is within the scope of the disclosure that the high-pressure zone temperature may be selected based on a thermal degradation temperature of any component(s) in the extract.

As another example, the high-pressure zone temperature may be less than the autoignition temperature of the solvent within the high-pressure zone. More specific examples of the high-pressure zone temperature include temperatures of at least −150° C., at least −140° C., at least −130° C., at least −120° C., at least −110° C., at least −100° C., at least −90° C., at least −80° C., at least −70° C., at least −60° C., at least −50° C., at least −40° C., at least −30° C., at least −20° C., at least−10° C., at least 0° C., at least 10° C., at least 20° C., at least 30° C., at least 40° C., at least 50° C., at most 100° C., at most 90° C., at most 80° C., at most 70° C., at most 60° C., at most 50° C., at most 40° C., at most 30° C., at most 20° C., at most 10° C., at most 0° C., at most −10° C., at most −20° C., at most −30° C., at most −40° C., at most −50° C., at most −60° C., at most −70° C., at most −80° C., at most −90° C., and/or at most −99° C.

Similarly, the high-pressure zone pressure may include and/or be any suitable pressure that maintains the solvent within the solvent liquid phase and/or within the solvent supercritical phase within the high-pressure zone when the solvent is at the high-pressure zone temperature. As an example, the high-pressure zone pressure may be greater than a high-pressure zone solvent vapor pressure of the solvent at the high-pressure zone temperature. As another example, the high-pressure zone pressure may be at least a threshold high-pressure zone pressure differential greater than the high-pressure zone solvent vapor pressure. Examples of the threshold high-pressure zone pressure differential include pressures of at least 5 kilopascals (kPa), at least 10 kPa, at least 20 kPa, at least 30 kPa, at least 40 kPa, at least 50 kPa, at least 75 kPa, at least 100 kPa, at least 150 kPa, at least 200 kPa, at most 1 megapascal (MPa), at most 900 kPa, at most 700 kPa, at most 600 kPa, at most 500 kPa, at most 400 kPa, at most 300 kPa, at most 200 kPa, at most 100 kPa, and/or at most 50 kPa. More specific examples of the high-pressure zone pressure include pressures of at least 5 kPa, at least 7 kPa, at least 10 kPa, at least 20 kPa, at least 30 kPa, at least 40 kPa, at least 50 kPa, at least 75 kPa, at

least 100 kPa, at least 150 kPa, at least 200 kPa, at least 400 kPa, at least 600 kPa, at least 800 kPa, at least 1 MPa, at least 2 MPa, at least 3 MPa, at least 4 MPa, at least 5 MPa, at most 7 MPa, at most 6 MPa, at most 5 MPa, at most 4 MPa, at most 3 MPa, at most 2 MPa, at most 1 MPa, at most 500 kPa, at most 400 kPa, at most 300 kPa, at most 200 kPa, at most 100 kPa, and/or at most 50 kPa.

Filter assembly 500 may include any suitable structure that may be adapted, configured, designed, and/or constructed to receive pressurized feed stream 302 and/or to separate the pressurized feed stream into permeate stream 510 and retentate stream 520 with, via, and/or utilizing filter element 502. As an example, filter assembly 500 may include and/or be a pressure-driven filter assembly configured to separate the pressurized feed stream into the permeate stream and the retentate stream responsive to a difference between the high-pressure zone pressure and the permeate zone pressure. Stated differently, the pressure difference between the high-pressure zone and the permeate zone may act as a driving force, or a motive force, for separation within the filter assembly. In some examples, filter assembly 500 may include a housing that contains and/or houses the filter element.

In some examples, filter element 502 may include and/or be a, or at least one, membrane filter element that includes at least one filtration membrane. The at least one filtration membrane may be configured in any suitable manner, examples of which include a single filtration membrane, a series arrangement of filtration membranes, a parallel arrangement of filtration membranes, one or more membrane packs, and/or one or more membrane envelopes. Additional examples of the membrane filter element include a tangential flow filtration element, a nanofiltration element, and/or an ultrafiltration element. Additional examples of filtration membranes include nanofiltration membranes and ultrafiltration membranes.

The at least one filtration membrane may include any suitable structure. Examples of the at least one filtration membrane include a polydimethylsiloxane outer layer supported by a polyacrylonitrile support layer, a polyimide outer layer supported by a polyacrylonitrile support layer, a silicone outer layer supported by a polyimide support layer, a graphene oxide outer layer supported by a polyvinylidene fluoride support layer, a nanoporous polyvinylidene fluoride filtration membrane, a titanium oxide filtration membrane, a functionalized titanium oxide filtration membrane, a zirconium oxide filtration membrane, a functionalized zirconium oxide filtration membrane, and/or an organic solvent nanofiltration membrane.

In more specific examples, the at least one filtration membrane includes a ceramic filtration membrane, such as the titanium oxide filtration membrane and/or the zirconium oxide filtration membrane. In some such examples, the ceramic filtration membrane may be a functionalized ceramic filtration membrane that includes a functionalized region, examples of which include a surface of the ceramic filtration membrane, an outer surface of the ceramic filtration membrane, a pore surface of the ceramic filtration membrane, and/or a functionalized outer layer of the ceramic filtration membrane. An example of the functionalized region includes a polydimethylsiloxane outer layer. Another example of the functionalized region includes a hydrophobic surface treatment. Examples of the hydrophobic surface treatment include treatments that produce and/or generate a hydrophobic group, a methyl group, a hexyl group, and/or a benzyl group on the surface of the ceramic filtration membrane. In specific examples, the surface of the ceramic filtration membrane may be functionalized utilizing a Grignard reagent to react hydrophilic functional groups and make them hydrophobic.

In some examples, filter element 502 may include a plurality of pores, such as may be sized to permit components of the extract that are less than a threshold size to pass therethrough while restricting passage of components of the extract that are greater than the threshold size. Stated differently, the pores may be sized and/or configured to permit the permeate fraction of the solvent and the permeate fraction of the extract to pass therethrough and/or to restrict passage of the retentate fraction of the extract from passing therethrough. The plurality of pores may define a pore size, an average pore size, and/or an effective pore size.

An example of the pore size includes pores that are in a nanofiltration size range. This may include pore sizes of at least 0.5 nanometers (nm), at least 0.6 nm, at least 0.7 nm, at least 0.8 nm, at least 0.9 nm, at least 1 nm, at least 2 nm, at least 3 nm, at least 4 nm, at least 5 nm, at least 6 nm, at least 7 nm, at least 8 nm, at least 9 nm, at least 10 nm, at most 20 nm, at most 18 nm, at most 16 nm, at most 14 nm, at most 12 nm, at most 10 nm, at most 9 nm, at most 8 nm, at most 7 nm, at most 6 nm, at most 5 nm, and/or at most 4 nm.

Another example of the pore size includes pores that are in an ultrafiltration size range. This may include pore sizes of at least 10 nm, at least 15 nm, at least 20 nm, at least 30 nm, at least 40 nm, at least 50 nm, at least 60 nm, at least 70 nm, at least 80 nm, at most 200 nm, at most 180 nm, at most 160 nm, at most 140 nm, at most 120 nm, at most 100 nm, at most 90 nm, at most 80 nm, at most 70 nm, at most 60 nm, at most 50 nm, at most 40 nm, at most 30 nm, and/or at most 20 nm.

Yet another example of the pore size includes pores that define a specified size exclusion rating, which also may be referred to herein as a molecular weight cutoff (MWCO). The size exclusion rating is defined as the smallest Dalton (Da) size of compound in a set solvent, which the manufacturer has tested to confirm at least 95% rejection under standard operation conditions defined for a given filter element. Examples of the specified size exclusion rating include at least 100 Da, at least 200 Da, at least 300 Da, at least 400 Da, at least 500 Da, at least 600 Da, at least 700 Da, at least 800 Da, at least 900 Da, at least 1,000 Da, at least 5,000 Da, at least 10,000 Da, at least 25,000 Da, at least 50,000 Da, at most 100,000 Da, at most 90,000 Da, at most 70,000 Da, at most 60,000 Da, at most 50,000 Da, at most 40,000 Da, at most 30,000 Da, at most 20,000 Da, at most 10,000 Da, at most 8,000 Da, at most 6,000 Da, at most 4,000 Da, at most 2,000 Da, at most 1,000 Da, at most 900 Da, at most 800 Da, at most 700 Da, at most 600 Da, and/or at most 500 Da for polystyrene in toluene.

Permeate zone 600 may include any suitable structure that may be adapted, configured, designed, and/or constructed to receive permeate stream 510 from filter assembly 500, and/or to maintain the permeate stream at the permeate zone temperature, and/or to maintain the permeate stream at the permeate zone pressure. As examples, permeate zone 600 may include any suitable permeate zone fluid conduit, permeate zone pipe, permeate zone fitting, and/or permeate zone valve. As additional examples, permeate zone 600 may include a permeate zone temperature sensor 602, a permeate zone pressure sensor 604, a permeate zone temperature regulation device 606, and/or a permeate zone pressure regulation device 608, as illustrated in FIG. 1. Permeate zone temperature sensor 602 and/or permeate zone temperature regulation device 606 may form a portion of temperature regulation system 1100, examples of which are discussed in more detail herein. Additionally or alternatively, permeate zone pressure sensor 604 and/or permeate zone pressure regulation device 608 may form a portion of pressure regulation system 1000, examples of which are discussed in more detail herein.

The permeate zone temperature may include and/or be any suitable temperature that maintains the solvent in the solvent liquid phase and/or in the solvent supercritical phase within the permeate zone when the solvent is at the permeate zone pressure. As an example, the permeate zone temperature may be less than a thermal degradation temperature of one or more thermally unstable components of the extract within the permeate zone. The selected, or designed-for, component associated with the thermal degradation temperature may be or include the most thermally unstable component of the extract, but it is within the scope of the disclosure that the permeate zone temperature may be selected based on a thermal degradation temperature of any component or components in the extract. As another example, the permeate zone temperature may be less than an autoignition temperature of the solvent within the permeate zone.

Similarly, the permeate zone pressure may include and/or be any suitable pressure that maintains the solvent within the solvent liquid phase and/or within the solvent supercritical phase within the permeate zone when the solvent is at the permeate zone temperature. As an example, the permeate zone pressure may be greater than a permeate zone solvent vapor pressure of the solvent at the permeate zone temperature. As another example, the permeate zone pressure may be at least a threshold permeate zone pressure differential greater than the permeate zone solvent vapor pressure. Examples of the threshold permeate zone pressure differential include at least 5 kPa, at least 10 kPa, at least 20 kPa, at least 30 kPa, at least 40 kPa, at least 50 kPa, at least 75 kPa, at least 100 kPa, at least 150 kPa, at least 200 kPa, at least 400 kPa, at least 600 kPa, at least 800 kPa, at least 1 MPa, at most 1.5 MPa, at most 1 MPa, at most 900 kPa, at most 700 kPa, at most 600 kPa, at most 500 kPa, at most 400 kPa, at most 300 kPa, at most 200 kPa, at most 100 kPa, and/or at most 50 kPa.

As another example, the permeate zone pressure may be less than the high-pressure zone pressure, such as to provide the driving force for separation within filter assembly 500. As more specific examples, a difference between the high-pressure zone pressure and the permeate zone pressure may be at least 4 kPa, at least 5 kPa, at least 10 kPa, at least 25 kPa, at least 50 kPa, at least 100 kPa, at least 200 kPa, at least 400 kPa, at least 600 kPa, at least 800 kPa, at least 1 MPa, at least 2 MPa, at least 3 MPa, at least 4 MPa, at most 6.5 MPa, at most 6 MPa, at most 5.5 MPa, at most 5 MPa, at most 4.5 MPa, at most 4 MPa, at most 3.5 MPa, at most 3 MPa, at most 2.5 MPa, at most 2 MPa, at most 1.5 MPa, at most 1 MPa, at most 800 kPa, at most 600 kPa, at most 400 kPa, at most 200 kPa, at most 100 kPa, at most 50 kPa, at most 25 kPa, at most 10 kPa, and/or at most 5 kPa.

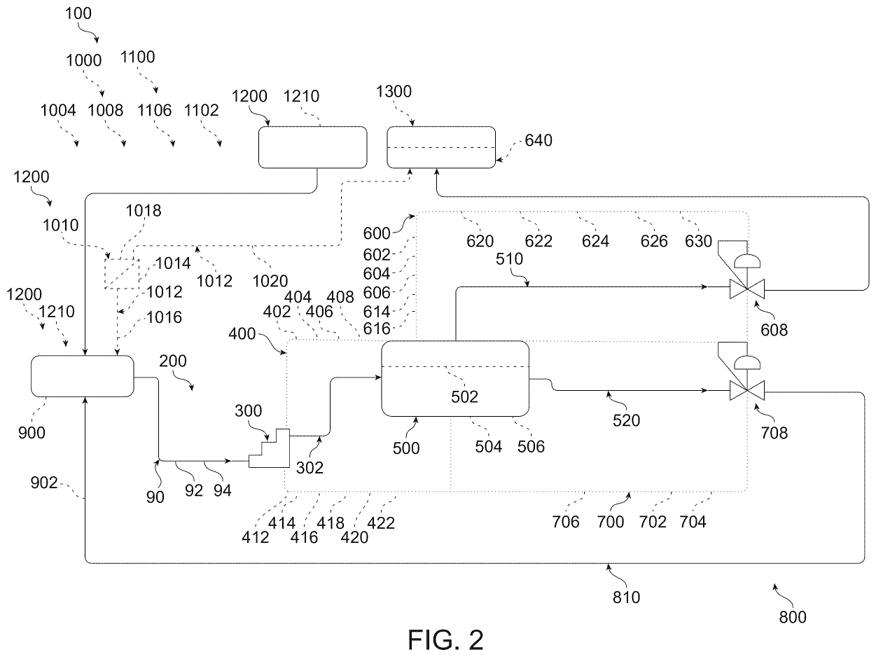

More specific examples of the permeate zone pressure include at least 5 kPa, at least 10 kPa, at least 25 kPa, at least 50 kPa, at least 100 kPa, at least 150 kPa, at least 200 kPa, at least 250 kPa, at least 300 kPa, at least 350 kPa, at least 400 kPa, at least 450 kPa, at least 500 kPa, at least 1 MPa, at least 2 MPa, at least 4 MPa, at least 6 MPa, at least 8 MPa, at least 10 MPa, at least 15 MPa, at least 20 MPa, at most 25 MPa, at most 20 MPa, at most 15 MPa, at most 10 MPa, at most 5 MPa, at most 1 MPa, at most 900 kPa, at most 800 kPa, at most 750 kPa, at most 700 kPa, at most 650 kPa, at most 600 kPa, at most 550 kPa, at most 500 kPa, at most 450 kPa, at most 400 kPa, at most 350 kPa, at most 300 kPa, at most 250 kPa, at most 200 kPa, at most 150 kPa, at most 100 kPa, at most 50 kPa, and/or at most 10 kPa. The permeate zone pressure may be selected based, at least in part, on the solvent and/or on a chemical identity of the solvent. As an example, when the solvent is butane, the permeate zone pressure may be at least 200 kPa and at most 450 kPa. As another example, when the solvent is propane, the permeate zone pressure may be at least 400 kPa and at most 650 kPa. In some examples, and as illustrated in dashed lines in FIG. 1 and in solid lines in FIGS. 2-3, separation systems 100 may include retentate zone 700. Retentate zone 700 may be configured to receive retentate stream 520 from filter assembly 500, to maintain the retentate stream at a retentate zone temperature, and/or to maintain the retentate stream at a retentate zone pressure. Examples of the retentate zone temperature are disclosed herein with reference to the high-pressure zone temperature. Examples of the retentate zone pressure are disclosed herein with reference to the high-pressure zone pressure.

Retentate zone 700 may include any suitable structure. As examples, retentate zone 700 may include any suitable retentate zone fluid conduit, retentate zone pipe, retentate zone fitting, and/or retentate zone valve. As additional examples, retentate zone 700 may include a retentate zone temperature sensor 702, a retentate zone pressure sensor 704, and/or a retentate zone temperature regulation device 706, as illustrated in FIGS. 1-2. As another example, retentate zone 700 may include a retentate zone pressure regulation device 708, as illustrated in FIGS. 1-3. Retentate zone temperature sensor 702 and/or retentate zone temperature regulation device 706 may form a portion of temperature regulation system 1100, examples of which are discussed in more detail herein. Additionally or alternatively, retentate zone pressure sensor 704 and/or retentate zone pressure regulation device 708 may form a portion of pressure regulation system 1000, examples of which are discussed in more detail herein.

As illustrated in dashed lines in FIG. 1 and in solid lines in FIGS. 2-3, separation systems 100 also may include a recirculation zone 800. Recirculation zone 800 may be configured to receive at least a recirculated fraction of retentate stream 520, such as from retentate zone 700 and/or from filter assembly 500, as a recirculation stream 810. Recirculation zone 800 additionally or alternatively may be configured to maintain the recirculation stream at a recirculation zone temperature and/or to maintain the recirculation stream at a recirculation zone pressure. Examples of the recirculation zone temperature are disclosed herein with reference to the feed zone temperature. Examples of the recirculation zone pressure are disclosed herein with reference to the feed zone pressure.

The recirculation zone also may be configured to provide at least a fraction of the recirculation stream to pressurization device 300. Pressurization device 300 then may be configured to pressurize the fraction of the recirculation stream to define at least a fraction of the pressurized feed stream. Stated differently, separation systems 100 that include recirculation zone 800 may be configured to recirculate the recirculated fraction of the retentate stream back to filter assembly 500, thereby permitting and/or facilitating improved separation of various components of the extract by the filter assembly.

Recirculation zone 800 may include any suitable structure. As examples, recirculation zone 800 may include any suitable recirculation zone fluid conduit, recirculation zone pipe, recirculation zone fitting, and/or recirculation zone valve. As additional examples, recirculation zone 800 may include a recirculation zone temperature sensor 802, a recirculation zone pressure sensor 804, a recirculation zone temperature regulation device 806, and/or a recirculation zone pressure regulation device 808, as illustrated in FIG. 1. Recirculation zone temperature sensor 802 and/or recirculation zone temperature regulation device 806 may form a portion of temperature regulation system 1100, examples of which are discussed in more detail herein. Additionally or alternatively, recirculation zone pressure sensor 804 and/or recirculation zone pressure regulation device 808 may form a portion of pressure regulation system 1000, examples of which are discussed in more detail herein.

As illustrated in dashed lines in FIGS. 1-2, separation systems 100 may include a retentate storage device 900. Retentate storage device 900 may be configured to receive a stored fraction 902 of retentate stream 520 and/or to store the stored fraction of the retentate stream, such as for later use within separation system 100 and/or within another system and/or process that is distinct from the separation system.

As discussed, separation systems 100 may include pressure regulation system 1000. Pressure regulation system 1000 may be configured to actively and/or passively control and/or regulate the pressure within one or more components and/or zones of the separation system, such as within feed zone 200, high-pressure zone 400, filter assembly 500, permeate zone 600, retentate zone 700, and/or recirculation zone 800. Stated differently, pressure regulation system 1000 may be configured to maintain the feed stream at the feed zone pressure, maintain the high-pressure zone at the high-pressure zone pressure, maintain the permeate zone at the permeate zone pressure, maintain the retentate zone at the retentate zone pressure, and/or maintain the recirculation zone at the recirculation zone pressure. This may be accomplished in any suitable manner.

As an example, pressure regulation system 1000 may include one or more pressure sensors 1004, such as feed zone pressure sensor 204, high-pressure zone pressure sensor 404, permeate zone pressure sensor 604, retentate zone pressure sensor 704, and/or recirculation zone pressure sensor 804. Examples of pressure sensors 1004 include diaphragm pressure sensors, strain gauge pressure sensors, piezoresistive pressure sensors, inductive pressure sensors, capacitive pressure sensors, and/or resonant pressure sensors.

As another example, pressure regulation system 1000 may include one or more pressure regulation devices 1008, such as feed zone pressure regulation device 208, high-pressure zone pressure regulation device 408, permeate zone pressure regulation device 608, retentate zone pressure regulation device 708, and/or recirculation zone pressure regulation device 808. Examples of pressure regulation devices 1008 include a back pressure regulator, a pilot controlled diaphragm back pressure regulator, an electronically pilot controlled diaphragm back pressure regulator, an electronically controlled diaphragm back pressure regulator, a spring-type diaphragm back pressure regulator, a piston-type diaphragm back pressure regulator, a poppet-type back pressure regulator, a needle valve, a fixed orifice, and/or a check valve with a predetermined break pressure. Another example of pressure regulation devices 1008 includes pressurization device 300.

As discussed in more detail herein, separation systems 100 are configured to maintain solvent 94 in the solvent liquid phase and/or in the solvent supercritical phase. This may include maintaining the solvent in the solvent liquid phase and/or in the solvent supercritical phase within an entirety of the separation systems and/or within every region, zone, and/or component

of the separation systems. As examples, separation systems 100 may be configured to maintain the solvent within the solvent liquid phase and/or within the solvent supercritical phase within feed zone 200, within pressurization device 300, within high-pressure zone 400, within filter assembly 500, within permeate zone 600, within retentate zone 700, within recirculation zone 800, and/or within retentate storage device 900. This may be accomplished in any suitable manner. As an example, pressure regulation system 1000 and/or temperature regulation system 1100 may be utilized to maintain temperatures and pressures within the various regions, zones, and/or components of the separation systems such that the solvent remains in the solvent liquid phase and/or in the solvent supercritical phase.

As is known in the art, it may be challenging to maintain solvent within permeate zone 600 and/or within permeate stream 510 within the solvent liquid phase and/or within the solvent supercritical phase due to a significant pressure drop across filter assembly 500 and/or across filter element 502 thereof. As is also known in the art, vaporization of the solvent within the permeate zone may cause the permeate fraction of the extract to fall out of the solvent, to solidify, to gel, and/or to be less soluble in the solvent, which may decrease an overall efficiency of conventional separation systems that permit this vaporization. However, separation systems 100 specifically are configured to avoid vaporization of solvent within the permeate stream and/or to maintain solvent within the permeate stream in the solvent liquid phase and/or in the solvent supercritical phase.

As an example, pressure regulation system 1000 and/or permeate zone 600 may include permeate zone pressure regulation device 608, such as a first permeate zone back flow check valve 620, a second permeate zone back flow check valve 622, a first permeate zone back pressure check valve 624, a second permeate zone back pressure check valve 626, and/or a permeate zone back-pressure regulator 634, examples of which are disclosed herein. The permeate zone pressure regulation device may be adapted, configured, designed, and/or constructed to maintain permeate zone 600 at the permeate zone pressure. This may be accomplished in any suitable manner. As an example, permeate zone pressure regulation device 608 may be positioned between permeate zone 600 and a component that is downstream from the permeate zone. As another example, permeate zone pressure regulation device 608 may fluidically separate the permeate zone from the component that is downstream from the permeate zone. In such a configuration, the permeate zone pressure regulation device may be configured to reduce a pressure of permeate stream 510 to a controlled, a specific, and/or a predetermined permeate zone pressure as the permeate stream flows from the permeate zone via the permeate zone pressure regulation device, thereby avoiding volatilization of solvent within the permeate stream and/or within the permeate zone.

As another example, pressure regulation system 1000 and/or permeate zone 600 may include and/or may be in fluid communication with a pressurized gas source 1010. The pressurized gas source may be configured to provide a pressurized gas stream 1012 to at least one other component of separation system 100, such as to maintain the at least one other component of the separation system at a corresponding component pressure. As more specific examples, and as illustrated in FIGS. 1-2, pressurized gas source 1010, or a feed zone pressurized gas source 1014, may be configured to provide pressurized gas stream 1012, or a feed pressurized gas stream 1016, to feed zone 200 to maintain feed zone 200 at the feed zone pressure. As another more specific example, and as also illustrated in FIGS. 1-2, pressurized gas source 1010, or a permeate pressurized gas source 1018, may be configured to provide pressurized gas stream 1012, or a permeate pressurized gas stream 1020, to permeate zone 600 to maintain permeate zone 600 at the permeate zone pressure. Examples of pressurized gas stream 1012, feed pressurized gas stream 1016, and/or permeate pressurized gas stream 1020 include a gas, an inert gas, and/or nitrogen gas. Examples of pressurized gas source 1010, feed zone pressurized gas source 1014, and/or permeate pressurized gas source 1018 include a volume of pressurized gas, a gas cylinder, a compressor, and/or a pressure regulator.

As also discussed, separation systems 100 may include temperature regulation system 1100. Temperature regulation system 1100 may be configured to actively and/or passively control and/or regulate the temperature within one or more components and/or zones of the separation system, such as within feed zone 200, high-pressure zone 400, filter assembly 500, permeate zone 600, retentate zone 700, and/or recirculation zone 800. Stated differently, temperature regulation system 1100 may be configured to maintain the feed stream at the feed zone temperature, maintain the high-pressure zone at the high-pressure zone temperature, maintain the permeate zone at the permeate zone temperature, maintain the retentate zone at the retentate zone temperature, and/or maintain the recirculation zone at the recirculation zone temperature. This may be accomplished in any suitable manner.

As an example, temperature regulation system 1100 may include one or more temperature sensors 1102, such as feed zone temperature sensor 202, high-pressure zone temperature sensor 402, permeate zone temperature sensor 602, retentate zone temperature sensor 702, and/or recirculation zone temperature sensor 802. Examples of temperature sensors 1102 include a thermocouple, a resistance temperature detector, a thermistor, and/or a semiconductor-based temperature sensor.

As another example, temperature regulation system 1100 may include one or more temperature regulation devices 1106, such as feed zone temperature regulation device 206, high-pressure zone temperature regulation device 406, permeate zone temperature regulation device 606, retentate zone temperature regulation device 706, and/or recirculation zone temperature regulation device 806. Examples of temperature regulation devices 1106 include thermal insulation, a temperature control device, an active temperature control device, a passive temperature control device, a heater, and/or a cooler.

As illustrated in dashed lines in FIGS. 1-3, separation systems 100 may include, may be associated with, and/or may be in fluid communication with a permeate stream separation device 1300, which may be configured to at least partially separate the permeate fraction of the solvent from the permeate fraction of the extract. Examples of permeate separation device 1300 include a permeate distillation device and/or a permeate distillation column.

As also illustrated in dashed lines in FIG. 1, separation systems 100 may include, may be associated with, and/or may be in fluid communication with a retentate stream separation device 1400, which may be configured to at least partially separate the retentate fraction of the solvent from the retentate fraction of the extract. Examples of the retentate separation device 1400 include a retentate distillation device and/or a retentate distillation column.

As illustrated in dashed lines in FIGS. 1-3, separation systems 100 may include, may be associated with, and/or may be in fluid communication with a feed stream supply system 1200. Feed stream supply system 1200 may be configured to produce at least one component of feed stream 90, such as extract 92 and/or solvent 94, and/or to provide the at least one component of the feed stream to feed zone 200. An example of feed stream supply system 1200 includes a closed-loop extraction device 1210, which may be configured to separate the extract from at least one component and/or to provide the extract to the feed zone within the feed stream.

More specific examples of separation system 100 are illustrated in FIG. 3. In the examples of FIG. 3, high-pressure zone 400 includes a high-pressure zone pressure regulation device 408, which may be in the form of a pressure relief valve. The high-pressure zone pressure regulation device 408 fluidly interconnects high-pressure zone 400 with recirculation zone 800, thereby permitting pressurized feed stream 302 directly to flow to the recirculation zone when the high-pressure zone pressure exceeds a predetermined and/or specified high-pressure zone pressure. Such a configuration may be utilized to avoid over-pressurization of the high-pressure zone. Additionally or alternatively, such a configuration may permit and/or facilitate maintaining the high-pressure zone pressure greater than the recirculation zone pressure.

Also in this example, high-pressure zone 400 includes high-pressure zone temperature sensor 402, high-pressure zone pressure sensor 404, and a pressurized feed stream flow meter 412. These sensing devices may be utilized to indicate and/or to facilitate regulation of the high-pressure zone temperature, the high-pressure zone pressure, and/or the flow rate of pressurized feed stream 302, such as via temperature regulation system 1100, pressure regulation system 1000, and/or pressurization device 300, respectively.

Also in this example, high-pressure zone 400 includes a first high-pressure zone valve assembly 414 and a second high-pressure zone valve assembly 416. First high-pressure zone valve assembly 414 may be utilized to permit and/or facilitate access to fluid flow within the high-pressure zone and/or evacuation of the high-pressure zone. As illustrated, separation system 100 optionally may include a plurality of filter assemblies 500, and second high-pressure zone valve assembly 416 may be utilized to select which filter assembly or assemblies of the plurality of filter assemblies receive the pressurized feed stream at a given point in time.

Also in this example, high-pressure zone 400 includes a first high-pressure zone check valve 420 and a second high-pressure zone check valve 422. First high-pressure zone check valve 420 may be configured to permit flow of permeate stream 510 from a first filter assembly 504 to permeate zone 600 and to restrict flow of the permeate stream from the permeate zone to the first filter assembly. Similarly, second high-pressure zone check valve 422 may be configured to permit flow of the permeate stream from a second filter assembly 506 to permeate zone 600 and to restrict flow of the permeate stream from the permeate zone to the second filter assembly.

Also in this example, permeate zone 600 includes a first permeate zone valve 614 and a second permeate zone valve 616. First permeate zone valve 614 may be configured to selectively permit or restrict flow of the permeate stream from first filter assembly 504 to the permeate zone, while second permeate zone valve 616 may be configured to selectively permit or restrict flow of the permeate stream from second filter assembly 506 to the permeate zone.

In addition, permeate zone 600 includes first permeate zone back flow check valve 620 and/or second permeate zone back flow check valve 622. First permeate zone back flow check valve 620 may be configured to permit flow of the permeate stream from the first filter assembly to the permeate zone and to restrict flow of the permeate stream from the permeate zone to the first filter assembly. Similarly, second permeate zone back flow check valve 622 may be configured to permit flow of the permeate stream from the second filter assembly to the permeate zone and to restrict flow of the permeate stream from the permeate zone to the second filter assembly. Such a configuration may decrease a potential for back-contamination of filter assemblies 500 and/or for entry of atmospheric air into the filter assemblies.

As also illustrated, permeate zone 600 includes first permeate zone back pressure check valve 624 and/or second permeate zone back pressure check valve 626. First permeate zone back pressure check valve 624 and second permeate zone back pressure check valve 626 may be configured to permit flow of the permeate stream from the first filter assembly and the second filter assembly, respectively, and/or from permeate zone 600, to high-pressure zone 400. Additionally or alternatively, the first permeate zone back pressure check valve and the second permeate zone back pressure check valve may be configured to restrict flow from the high-pressure zone to the first filter assembly and the second filter assembly, respectively, and/or to the permeate zone. Such a configuration may decrease a potential for over-pressurization of the permeate zone and/or may permit and/or facilitate purging of the permeate zone via back-pressurization of the permeate zone with a purge fluid stream. First permeate zone back pressure check valve 624 additionally or alternatively may include one or more other first back pressure regulating devices, such as a first permeate zone back pressure regulator. Similarly, second permeate zone back pressure check valve 626 additionally or alternatively may include one more other second back pressure regulating devices, such as a second permeate zone back pressure regulator.

In addition, permeate zone 600 may include a permeate zone flow meter 630, a permeate zone pressure sensor 632, permeate zone back-pressure regulator 634, and/or a permeate zone three-way valve 636. The permeate zone flow meter may be configured to indicate, measure, and/or detect a flow rate of permeate stream 510 from permeate zone 600. Similarly, permeate zone pressure sensor 632 may be configured to indicate, measure, and/or detect a pressure of the permeate stream. Permeate zone back-pressure regulator 634 may be configured to control and/or regulate a pressure within a region of permeate zone 600 that extends between filter assembly 500 and the permeate zone back-pressure regulator. Such a configuration may be utilized to decrease a potential for vaporization, volatilization, and/or cavitation of solvent that is present within this region of the separation system. Stated differently, the presence of permeate zone back-pressure regulator 634 may ensure that solvent that passes through filter assembly 500 remains in the solvent liquid phase and/or in the solvent supercritical phase despite pressure drops across the filter assembly. Permeate zone three-way valve 636 may be utilized to selectively recycle and/or redirect a portion, or even all, of permeate stream 510 into recirculation zone 800. Such a configuration may permit and/or facilitate return of the portion of the permeate stream to a mixing tank 1222 and/or increased and/or repeated filtration of the portion of the permeate stream.

Also in this example, retentate zone 700 includes a retentate zone pressure regulation device 708, which may be in the form of a pressure relief valve. The retentate zone pressure regulation device fluidly interconnects retentate zone 700 with recirculation zone 800, thereby permitting retentate stream 520 to flow to the recirculation zone and/or to be recirculated within the separation system. Such a configuration may permit and/or facilitate maintaining the retentate zone pressure greater than the recirculation zone pressure.

Also in this example, recirculation zone 800 includes a first recirculation zone check valve 820. First recirculation zone check valve 820 may be configured to permit flow of recirculation stream 810 from recirculation zone 800 to feed zone 200 and/or to pressurization device 300 and to restrict flow of the recirculation stream and/or of feed stream 90 from the feed zone and/or from the pressurization device to the recirculation zone.

The example of FIG. 3 also provides a more detailed view of examples of feed stream supply system 1200. In this example, extract 92 is provided, such as from and/or via closed-loop extraction device 1210, via a first feed stream supply system valve 1220 and/or to mixing tank 1222. Also in this example, recirculation zone 800 may be configured to return at least a fraction of recirculation stream 810 to the mixing tank. Such a configuration may permit and/or facilitate storage of the recirculation stream and/or mixing of the recirculation stream with the extract. Additionally or alternatively, and as discussed in more detail herein, such a configuration may permit and/or facilitate mixing of the extract and/or of the recirculation stream with solvent 94.

Also in this example, solvent 94 is provided, such as from a solvent source 1230, via a second feed stream supply system valve 1232 and/or to a solvent storage tank 1234. Such a configuration may permit and/or facilitate storage of a volume of solvent 94 within and/or proximate the separation system. Solvent 94 then may be provided, via a solvent pump 1236 to mixing tank 1222, such as to permit and/or facilitate mixing of the solvent with extract 92 and/or with recirculation stream 810. A solvent flow meter 1238 may be utilized to monitor, detect, and/or quantify a flow rate of the solvent from the solvent storage tank and/or to the mixing tank. In addition, a solvent pressure relief valve 1240 may be utilized to maintain a pressure differential generated by the solvent pump at or below a predetermined pressure differential.

Also in this example, temperature regulation system 1100 includes a feed stream supply system temperature regulation device 1250 that may be utilized to control and/or regulate a temperature of extract 92 prior to supply of the extract to mixing tank 1222 and/or to control and/or regulate a temperature of solvent 94 prior to supply of the solvent to solvent storage tank 1234. An example of feed stream supply system temperature regulation device 1250 includes a heat exchanger 1252, which may be configured to exchange thermal energy between a thermal exchange fluid stream 1254 and the extract and/or the solvent. As an example, extract 92 may be provided to mixing tank 1222 via feed stream supply system temperature regulation device 1250 and a corresponding extract valve 1256. Additionally or alternatively, solvent 94 may be provided to solvent storage tank 1234 via feed stream supply system temperature regulation device 1250 and a corresponding solvent valve 1258.

Also in this example, pressure regulation system 1000 may include a feed stream pressure relief system 1260, which may be configured to maintain pressure within mixing tank 1222 and/or within solvent storage tank 1234 below a predetermined feed stream supply system pressure. As an example, feed stream pressure relief system 1260 may include a solvent storage tank pressure relief valve 1262, which may be configured to relieve pressure within the solvent storage tank when the pressure within the solvent storage tank is greater than the predetermined feed stream supply system pressure. Additionally or alternatively, feed stream pressure relief system 1260 may include a mixing tank pressure relief valve 1264, which may be configured to relive pressure within the mixing tank when the pressure within the mixing tank is greater than the predetermined feed stream supply system pressure.

Also in this example, feed stream supply system 1200 may include an evacuation system 1270. Evacuation system 1270 may be configured to permit and/or facilitate evacuation of at least a portion of separation system 100, such as to decrease a potential for contamination within the separation system and/or to decrease a potential for contact between atmospheric oxygen and feed stream 90, extract 92, and/or solvent 94. As illustrated, evacuation system 1270 may include a solvent storage tank evacuation valve 1272, a mixing tank evacuation valve 1274, and/or an evacuation fitting 1276. Solvent storage tank evacuation valve 1272 may be opened to selectively permit evacuation of at least solvent storage tank 1234, and solvent storage tank evacuation valve 1272 subsequently may be closed to seal the solvent storage tank. Similarly, mixing tank evacuation valve 1274 may be opened to selectively permit evacuation of at least mixing tank 1222, and mixing tank evacuation valve 1274 subsequently may be closed to seal the mixing tank. Evacuation fitting 1276 may be connected to a vacuum source, which may be utilized to apply a vacuum to the evacuation system.

Extract 92 may include and/or be any suitable material that is produced by, obtained from, and/or extracted from a plant, a fungus, and/or an animal. Examples of extract 92 include a botanical extract, a fungal extract, and/or an animal product extract. In some examples and as discussed, extract 92 may be generated utilizing a closed-loop extraction process. In some examples, the extract may include a plurality of micelles suspended within an extraction solvent, which may be the same solvent as solvent 94. In more specific examples, the extract may include one or more of a cannabis extract, cannabinoids, tetrahydrocannabinol (THC), cannabidiol (CBD), tetrahydrocannabinolic acid (THCA), cannabidiolic acid (CBDA), cannabichromenic acid (CBCA), cannabinoid acids, cannabitriol, cannabielsoin, a wax, a fat, a fatty acid, an ester, a color body, a pigment, chlorophyll, an oxidative degradation product of chlorophyll, and/or a terpene.

While the present disclosure is related to separation systems for separating components of an extract suspended within a solvent and related methods, the disclosed systems and methods may be equally applicable to separation of other and/or additional biological materials from a solvent. Examples of these biological materials include extracts, secretions, and/or waste products from animals, livestock, insects, and/or other multi-cellular organisms. Additional examples of these biological materials include other biological materials that may be suspended within a solvent. In some examples, the biological materials may exclude extracts, secretions, and/or waste products from single-cellular organisms, yeast, algae, and/or bacteria; however, this is not required, and it is within the scope of the present disclosure that the disclosed separation systems and methods also may be applied to such extracts, secretions, and/or waste products. With the above in mind, it is within the scope of the present disclosure that extracts 92 may include, or instead may be, biological materials, examples of which are disclosed herein.

Solvent 94 may include any suitable solvent that may be in the solvent gas phase at standard temperature and pressure. Stated differently, a solvent vapor pressure of the solvent may be greater than 101.3 kPa at 0° C., and/or the solvent may be in the solvent gas phase at 101.3 kPa and 0° C. Examples of the solvent include an organic solvent, a hydrocarbon solvent, an aliphatic hydrocarbon solvent, methane, ethane, propane, butane, n-butane, isobutane, and/or a fluorocarbon. Additional examples of the solvent may include at least 50 weight percentage (wt %) of one or more of the above-listed materials together with another material and/or solvent. Another example of the solvent includes a gas expanded liquid solvent. Stated differently, the solvent may include a gaseous additive, which may define at most 25 wt % of the solvent. Examples of the gaseous additive include carbon dioxide, nitrogen, hydrogen, helium, argon, xenon, and/or nitrous oxide.

FIG. 6 is a flowchart illustrating examples of methods 1500 of separating components of an extract suspended within a solvent utilizing separation systems, according to the present disclosure. Examples of the separation system, components thereof, and/or streams that may flow therewithin are disclosed herein with reference to separation systems 100 of FIGS. 1-6. Methods 1500 may include providing a feed stream at 1505, and methods 1500 include receiving the feed stream with a pressurization device at 1510. Methods 1500 also include receiving a pressurized feed stream into a high-pressure zone at 1515 and receiving the pressurized feed stream into a filter assembly at 1520. Methods 1500 further include separating the pressurized feed stream at 1525 and receiving a permeate stream at 1530. Methods 1500 further may include recirculating a retentate stream at 1535, replacing a filter element at 1540, repeating at 1545, and/or distilling at 1550.

Providing the feed stream at 1505 may include providing the feed stream to a feed zone of the separation system and/or flowing the feed stream into and/or within the feed zone. The providing at 1505 may be performed in any suitable manner. As an example, the providing at 1505 may include providing the feed stream from a source of the feed stream and/or from a stored volume of the feed stream. As another example, the providing the feed stream may include performing a closed-loop extraction process to separate an extract, such as from plant material, fungal material, and/or animal material. As yet another example, the providing at 1505 may include mixing a solvent with the extract to form and/or define the feed stream.

The providing at 1505 additionally or alternatively may include maintaining the feed stream at a feed zone temperature and a feed zone pressure, such as while the feed stream is within the feed zone. The maintaining the feed stream at the feed zone temperature may include maintaining the feed stream at the feed zone temperature utilizing a feed zone temperature sensor and/or utilizing a feed zone temperature regulation device of the separation system. The maintaining the feed stream at the feed zone pressure may include maintaining the feed zone pressure utilizing a feed zone pressure sensor and/or utilizing a feed zone pressure regulation device of the separation system.

Receiving the feed stream with the pressurization device at 1510 may include flowing the feed stream from the feed zone, and to and/or into a pressurization device of the separation system. Additionally or alternatively, the receiving at 1510 may include utilizing the pressurization device to pressurize the feed stream and/or to define a pressurized feed stream.

Receiving the pressurized feed stream into the high-pressure zone at 1515 may include flowing the pressurized feed stream from the pressurization device and/or into a high-pressure zone of the separation system. The receiving at 1515 additionally or alternatively may include maintaining the pressurized feed stream at a high-pressure zone temperature and/or at a high-pressure zone pressure, such as while the pressurized feed stream is within the high-pressure zone. The maintaining the pressurized feed stream at the high-pressure zone temperature may include maintaining the pressurized feed stream at the high-pressure zone temperature utilizing a high-pressure zone temperature sensor and/or utilizing a high-pressure zone temperature regulation device of the separation system. The maintaining the pressurized feed stream at the high-pressure zone pressure may include maintaining the pressurized feed stream at the high-pressure zone pressure utilizing a high-pressure zone pressure sensor and/or utilizing a high-pressure zone pressure regulation device of the separation system.

Receiving the pressurized feed stream into the filter assembly at 1520 may include flowing the pressurized feed stream from the high-pressure zone and/or into a filter assembly of the separation system. This may include flowing the pressurized feed stream into fluid contact with a filter element of the filter assembly.

Separating the pressurized feed stream at 1525 may include separating the pressurized feed stream utilizing the filter element of the filter assembly. This may include separating the pressurized feed stream into, to produce, and/or to generate a permeate stream and a retentate stream. As discussed in more detail herein, the permeate stream includes a permeate fraction of the solvent and a permeate fraction of the extract that pass through the filter element, and the retentate stream includes a retentate fraction of the solvent and a retentate fraction of the extract that that do not pass through the filter element.

Receiving the permeate stream at 1530 may include flowing the permeate stream from the filter assembly and/or into a permeate zone of the separation system. Additionally or alternatively, the receiving at 1530 may include maintaining the permeate stream at a permeate zone temperature and/or at a permeate zone pressure, such as while the permeate stream is within the permeate zone. The maintaining the permeate stream at the permeate zone temperature may include maintaining the permeate stream at the permeate zone temperature utilizing a permeate zone temperature sensor and/or utilizing a permeate zone temperature regulation device of the separation system. The maintaining the permeate stream at the permeate zone pressure may include maintaining the permeate zone pressure utilizing a permeate zone pressure sensor and/or utilizing a permeate zone pressure regulation device of the separation system.

Recirculating the retentate stream at 1535 may include recirculating at least a recirculated fraction of the retentate stream to the pressurization device. The recirculating at 1535 additionally or alternatively may include pressurizing the recirculated fraction of the retentate stream with the pressurization device to define at least a fraction of the pressurized feed stream. In some examples, the recirculating at 1535 may include recirculating from a retentate zone of the separation system. In some examples, the recirculating at 1535 may include recirculating at least partially via a recirculation zone of the separation system. In some examples, the recirculating at 1535 may include continuously recirculating at least the recirculated fraction of the retentate stream for at least a threshold recirculation time.

In some examples, methods 1500 may be utilized to separate components of an extract in the form of a botanical extract that includes, or is, a cannabis extract. The cannabis extract may include cannabinoids.

As an example, methods 1500 may include dewaxing and/or decoloring the cannabis extract. In such examples, the retentate stream may include at least a majority fraction of compounds within the cannabis extract that are larger than the cannabinoids. Additionally or alternatively, the permeate stream may include at least a majority fraction of the cannabinoids, and also at least a majority fraction of compounds within the cannabis extract that are smaller than the cannabinoids. Examples of the compounds within the cannabis extract that are larger than the cannabinoids include lipids, waxes, fats, fatty acids, esters, color bodies, pigments, chlorophyll, and/or oxidative degradation products of chlorophyll. Examples of the compounds within the cannabis extract that are smaller than the cannabinoids include terpenes.

As another example, methods 1500 may include separating terpenes from the cannabinoids within the cannabis extract. In such examples, the retentate stream may include at least a majority fraction of the cannabinoids. Additionally or alternatively, the permeate stream may include at least a majority fraction of the terpenes and/or of other components that are smaller than the cannabinoids from the feed stream.

In some examples, methods 1500 may include purifying the solvent. In such examples, the retentate stream may include at least a majority fraction, such as at least 60 wt %, at least 70 wt %, at least 80 wt %, or at least 90 wt %, of components of the extract from the feed stream. Additionally or alternatively, the permeate stream may include at least a majority fraction, such as at least 60 wt %, at least 70 wt %, at least 80 wt %, or at least 90 wt %, of the solvent from the feed stream. Also in such examples, methods 1500 may include purifying the solvent without distilling the feed stream. This is in contrast to a conventional solvent purification process that relies on distillation and thus is significantly more energy-intensive and/or equipment-intensive when compared to methods 1500.

Replacing the filter element at 1540 may include changing, cleaning, and/or replacing the filter element in any suitable manner and/or for any suitable purpose. As an example, the replacing at 1540 may include replacing the filter element with a clean filter element and/or cleaning the filter element, such as to increase a flow rate of the permeate stream through the filter element. As another example, and as discussed in more detail herein, the replacing at 1540 may include replacing the filter element with another filter element that defines a different pore size and/or that is configured to differently separate components of the extract.

Repeating at 1545 may include repeating any suitable step and/or steps of methods 1500 in any suitable manner. As an example, and as discussed, methods 1500 may be utilized to dewax and decolor the cannabis extract, to separate terpenes from the cannabis extract, and/or to purify the solvent. In such examples, methods 1500 may be referred to herein as methods of purifying a cannabis extract that includes cannabinoids and/or as methods of separating the cannabinoids from other components of the cannabis extract. Also in such examples, the providing at 1505 may include performing a closed-loop extraction process to separate the cannabis extract from at least one component of a cannabis plant. Also in such examples, methods 1500 may be performed a plurality of times, such as to accomplish various separations and/or to provide a desired final product.

As an example, the providing at 1505 may include providing a feed stream that includes the cannabis extract suspended within a solvent, and methods 1500 may include performing a first separation to dewax and decolor the feed stream by performing at least the receiving at 1510, the receiving at 1515, the receiving at 1520, the separating at 1525, and the receiving at 1530 to generate a first retentate stream and a first permeate stream. The first retentate stream may include the at least the majority fraction of compounds within the cannabis extract that are larger than the cannabinoids, and the first permeate stream may include the at least the majority fraction of the cannabinoids and also at least a majority fraction of compounds within the cannabis extract that are smaller than the cannabinoids.

In this example, the repeating at 1545 subsequently may include performing a second separation to separate terpenes from the cannabinoids within the first permeate stream by repeating at least the receiving at 1510, the receiving at 1515, the receiving at 1520, the separating at 1525, and the receiving at 1530 utilizing the first permeate stream as the feed stream. This may include repeating to generate a second retentate stream and a second permeate stream. The second retentate stream may include at least a majority fraction of the cannabinoids, and the second permeate stream may include at least a majority fraction of the terpenes and other components that are smaller than the cannabinoids.

To facilitate the above separations, and during the performing the first separation, the filter element may be a first filter element, and prior to the performing the second separation, the method may include performing the replacing at 1540 to replace the first filter element with a second filter element. The second filter element may differ from the first filter element. As an example, a first pore size, or an average first pore size, of the first filter element may be greater than a second pore size, or an average second pore size, of the second filter element.

As another example, the providing at 1505 may include providing a feed stream that includes the cannabis extract suspended within a solvent, and methods 1500 may include performing a first separation to separate terpenes from the feed stream by performing at least the receiving at 1510, the receiving at 1515, the receiving at 1520, the separating at 1525, and the receiving at 1530 to generate a first retentate stream and a first permeate stream. The first retentate stream may include the at least the majority fraction of the cannabinoids and other compounds within the cannabis extract that are larger than the terpenes, and the first permeate stream may include the at least the majority fraction of the terpenes.

In this example, the repeating at 1545 subsequently may include performing a second separation to dewax and decolor the cannabinoids by repeating at least the receiving at 1510, the receiving at 1515, the receiving at 1520, the separating at 1525, and the receiving at 1530 utilizing the first retentate stream as the feed stream. This may include repeating to generate a second retentate stream and a second permeate stream. The second permeate stream may include at least a majority fraction of the cannabinoids, and the second retentate stream may include at least a majority fraction of the compounds within the cannabis extract that are larger than the cannabinoids.

To facilitate the above separations, and during the performing the first separation, the filter element may be a first filter element, and prior to the performing the second separation, the method may include performing the replacing at 1540 to replace the first filter element with a second filter element. The second filter element may differ from the first filter element. As an example, a first pore size, or an average first pore size, of the first filter element may be less than a second pore size, or an average second pore size, of the second filter element.

As discussed, methods 1500 also may be utilized to separate solvent from one or more other components of the cannabis extract. This may be performed with any suitable timing and/or sequence during methods 1500. As an example, and prior to performing the first separation, the method may include performing a preliminary separation by performing at least the receiving at 1510, the receiving at 1515, the receiving at 1520, the separating at 1525, and the receiving at 1530 on the feed stream to separate solvent from the feed stream. During the initial separation, the retentate stream may be an initial retentate stream and the permeate stream may be an initial permeate stream. In this example, the performing the first separation may include performing the first separation utilizing the initial retentate stream as the feed stream.

As another example, and subsequent to performing the first separation but prior to performing the second separation, the method may include performing an intermediate separation. In some such examples, the performing the intermediate separation may include by repeating at least the receiving at 1510, the receiving at 1515, the receiving at 1520, the separating at 1525, and the receiving at 1530 utilizing the first retentate stream as the feed stream to separate solvent from the first retentate stream. Alternatively, and in some such examples, the performing the intermediate separation may include by repeating at least the receiving at 1510, the receiving at 1515, the receiving at 1520, the separating at 1525, and the receiving at 1530 utilizing the first permeate stream as the feed stream to separate solvent from the first permeate stream. During such intermediate separations, the retentate stream may be an intermediate retentate stream and the permeate stream is an intermediate permeate stream. Also during such intermediate separations, the performing the second separation includes performing the second separation utilizing the intermediate retentate stream as the feed stream.

As yet another example, and subsequent to performing the second separation, the repeating at 1545 may include performing a third separation to purify the solvent by repeating at least the receiving at 1510, the receiving at 1515, the receiving at 1520, the separating at 1525, and the receiving at 1530 utilizing the second permeate stream as the feed stream to separate solvent from the second permeate stream. This may include repeating to generate a third retentate stream and a third permeate stream. The third retentate stream may include at least a majority fraction, such as at least 90 wt %, of components of the extract from the feed stream, and the third permeate stream may include at least a majority fraction, such as at least 90 wt %, of the solvent from the feed stream. In such examples, the repeating at 1545 also may include repeating the first separation utilizing the third permeate stream as the solvent. Stated differently, methods 1500 may be utilized to recycle, recover, and/or re-use the solvent.

Distilling at 1550 may include distilling the retentate stream. This may include distilling the retentate stream to concentrate the retentate fraction of the extract. In a specific example, such as when methods 1500 include performing the first separation and the second separation, the distilling at 1550 may include distilling the second retentate stream to concentrate the cannabinoids and/or to define a cannabinoid product stream.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or

exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are within 75% of the second length and also includes first lengths that are as long as the second length.

Illustrative, non-exclusive examples of separation systems and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.
A1. A separation system for separating components of an extract suspended within a solvent, wherein the extract includes at least one of a botanical extract, a fungal extract, and an animal product extract, optionally wherein the solvent is in a solvent gas phase at standard temperature and pressure, and further wherein the separation system is configured to maintain the solvent in at least one of a solvent liquid phase and a solvent supercritical phase, the separation system comprising:
a feed zone configured to receive a feed stream that includes the extract suspended within the solvent and to maintain the feed stream at a feed zone temperature and a feed zone pressure;
a pressurization device configured to pressurize the feed stream to define a pressurized feed stream;
a high-pressure zone configured to receive the pressurized feed stream and to maintain the pressurized feed stream at a high-pressure zone temperature and a high-pressure zone pressure;
a filter assembly that includes a filter element configured to receive the pressurized feed stream and to separate the pressurized feed stream into a permeate stream, which includes a permeate fraction of the solvent, and optionally a permeate fraction of the extract, that passes through the filter element, and a retentate stream, which includes a retentate fraction of the solvent, and optionally a retentate fraction of the extract, that does not pass through the filter element; and
a permeate zone configured to receive the permeate stream from the filter assembly and to maintain the permeate stream at least one of at a permeate zone temperature and at a permeate zone pressure.
A2. The separation system of paragraph A1, wherein the feed zone temperature is less than a thermal degradation temperature of a thermally unstable, or a most thermally unstable, component of the extract within the feed zone.
A3. The separation system of any of paragraphs A1-A2, wherein the feed zone temperature is less than an autoignition temperature of the solvent within the feed zone.
A4. The separation system of any of paragraphs A1-A3, wherein the feed zone temperature is at least one of:
(i) at least −150 degrees Celsius (° C.), at least −140° C., at least −130° C., at least −120° C., at least −110° C., at least −100° C., at least −90° C., at least −80° C., at least −70° C., at least −60° C., at least −50° C., at least −40° C., at least −30° C., at least −20° C., at least −10° C., at least 0° C., at least 10° C., at least 20° C., at least 30° C., at least 40° C., or at least 50° C.; and
(ii) at most 100° C., at most 90° C., at most 80° C., at most 70° C., at most 60° C., at most 50° C., at most 40° C., at most 30° C., at most 20° C., at most 10° C., at most 0° C., at most −10° C., at most −20° C., at most −30° C., at most −40° C., at most −50° C., at most −60° C., at most −70° C., at most −80° C., at most −90° C., at most −99° C., or at most −100° C..
A5. The separation system of any of paragraphs A1-A4, wherein the feed zone pressure is greater than a feed zone solvent vapor pressure of the solvent at the feed zone temperature, optionally wherein the feed zone pressure is at least a threshold feed zone pressure differential greater than the feed zone solvent vapor pressure, and further optionally wherein the threshold feed zone pressure differential is at least one of:
(i) at least 5 kilopascals (kPa), at least 10 kPa, at least 20 kPa, at least 30 kPa, at least 40 kPa, at least 50 kPa, at least 75 kPa, at least 100 kPa, at least 150 kPa, at least 200 kPa, at least 500 kPa, at least 750 kPa, at least 1 megapascal (MPa), at least 5 MPa, at least 10 MPa, at least 15 MPa, or at least 20 MPa; and
(ii) at most 30 MPa, at most 25 MPa, at most 20 MPa, at most 15 MPa, at most 10 MPa, at most 5 MPa, at most 1 MPa, at most 900 kPa, at most 700 kPa, at most 600 kPa, at most 500 kPa, at most 400 kPa, at most 300 kPa, at
most 200 kPa, at most 100 kPa, at most 50 kPa, at most 40 kPa, at most 30 kPa, at most 20 kPa, at most 10 kPa, at most 9 kPa, at most 8 kPa, at most 7 kPa, at most 6 kPa, or at most 5 kPa.
A6. The separation system of any of paragraphs A1-A5, wherein the pressurization device includes at least one of a pump, a positive displacement pump, a pressure exchange device, and a centrifugal pump.
A7. The separation system of any of paragraphs A1-A6, wherein the pressurization device is configured to generate a pressurization device pressure differential between the feed stream and the pressurized feed stream that is at least as large as a pressure differential between the high-pressure zone pressure and the feed zone pressure.
A8. The separation system of paragraph A7, wherein the pressurization device pressure differential is at least one of:
(i) at least 5 kPa, at least 10 kPa, at least 20 kPa, at least 30 kPa, at least 40 kPa, at least 50 kPa, at least 100 kPa, at least 150 kPa, at least 200 kPa, at least 400 kPa, at least 600 kPa, at least 800 kPa, at least 1 MPa, at least 2 MPa, at least 3 MPa, at least 4 MPa, or at least 5 MPa; and
(ii) at most 7 MPa, at most 6 MPa, at most 5 MPa, at most 4 MPa, at most 3 MPa, at most 2 MPa, at most 1 MPa, at most 500 kPa, at most 400 kPa, at most 300 kPa, at most 200 kPa, at most 100 kPa, at most 50 kPa, at most 40 kPa, at most 30 kPa, at most 20 kPa, at most 10 kPa, at most 9 kPa, at most 8 kPa, at most 7 kPa, at most 6 kPa, or at most 5 kPa.
A9. The separation system of any of paragraphs A1-A8, wherein the high-pressure zone temperature is less than a/the thermal degradation temperature of a/the thermally unstable, or a/the most thermally unstable, component of the extract within the high-pressure zone.
A10. The separation system of any of paragraphs A1-A9, wherein the high-pressure zone temperature is less than an/the autoignition temperature of the solvent within the high-pressure zone.
A11. The separation system of any of paragraphs A1-A10, wherein the high-pressure zone temperature is at least one of:
(i) at least −150° C., at least −140° C., at least −130° C., at least −120° C., at least −110° C., at least −100° C., at least −90° C., at least −80° C., at least −70° C., at least −60° C., at least −50° C., at least −40° C., at least −30° C., at least −20° C., at least −10° C., at least 0° C., at least 10° C., at least 20° C., at least 30° C., at least 40° C., or at least 50° C.; and
(ii) at most 100° C., at most 90° C., at most 80° C., at most 70° C., at most 60° C., at most 50° C., at most 40° C., at most 30° C., at most 20° C., at most 10° C., at most 0° C., at most −10° C., at most −20° C., at most −30° C., at most −40° C., at most −50° C., at most −60° C., at most −70° C., at most −80° C., at most −90° C., or at most−99° C.
A12. The separation system of any of paragraphs A1-A11, wherein the high-pressure zone pressure is greater than a high-pressure zone solvent vapor pressure of the solvent at the high-pressure zone temperature, optionally wherein the high-pressure zone pressure is at least a threshold high-pressure zone pressure differential greater than the high-pressure zone solvent vapor pressure, and further optionally wherein the threshold high-pressure zone pressure differential is at least one of:
(i) at least 5 kPa, at least 10 kPa, at least 20 kPa, at least 30 kPa, at least 40 kPa, at least 50 kPa, at least 75 kPa, at least 100 kPa, at least 150 kPa, or at least 200 kPa; and
(ii) at most 1 MPa, at most 900 kPa, at most 700 kPa, at most 600 kPa, at most 500 kPa, at most 400 kPa, at most 300 kPa, at most 200 kPa, at most 100 kPa, or at most 50 kPa.
A13. The separation system of any of paragraphs A1-A12, wherein the high-pressure zone pressure is at least one of:
(i) at least 5 kPa, at least 7 kPa, at least 10 kPa, at least 20 kPa, at least 30 kPa, at least 40 kPa, at least 50 kPa, at least 75 kPa, at least 100 kPa, at least 150 kPa, at least 200 kPa, at least 400 kPa, at least 600 kPa, at least 800 kPa, at least 1 MPa, at least 2 MPa, at least 3 MPa, at least 4 MPa, or at least 5 MPa; and
(ii) at most 7 MPa, at most 6 MPa, at most 5 MPa, at most 4 MPa, at most 3 MPa, at most 2 MPa, at most 1 MPa, at most 500 kPa, at most 400 kPa, at most 300 kPa, at most 200 kPa, at most 100 kPa, or at most 50 kPa.
A14. The separation system of any of paragraphs A1-A13, wherein the filter assembly is a pressure-driven filter assembly configured to separate the pressurized feed stream into the permeate stream and the retentate stream responsive to a difference between the high-pressure zone pressure and the permeate zone pressure.
A15. The separation system of any of paragraphs A1-A14, wherein the filter element includes, or is, a membrane filter element that includes at least one filtration membrane.
A16. The separation system of paragraph A15, wherein the membrane filter element includes, or is, at least one of a tangential flow filtration element, a nanofiltration element, and an ultrafiltration element.
A17. The separation system of any of paragraphs A15-A16, wherein the at least one filtration membrane includes, or is, at least one of:
(i) a polydimethylsiloxane outer layer supported by a polyacrylonitrile support layer;
(ii) a polyimide outer layer supported by a polyacrylonitrile support layer;
(iii) a silicone outer layer supported by a polyimide support layer;
(iv) a graphene oxide outer layer supported by a polyvinylidene fluoride support layer;
(v) a nanoporous polyvinylidene fluoride filtration membrane;
(vi) a titanium oxide filtration membrane;
(vii) a functionalized titanium oxide filtration membrane;
(viii) a zirconium oxide filtration membrane;
(ix) a functionalized zirconium oxide filtration membrane; and
(x) an organic solvent nanofiltration membrane.
A18. The separation system of any of paragraphs A15-A17, wherein the at least one filtration membrane includes, or is, a ceramic filtration membrane.
A19. The separation system of paragraph A18, wherein the ceramic filtration membrane is a functionalized ceramic filtration membrane that includes a functionalized region.
A20. The separation system of paragraph A19, wherein the functionalized region includes a functionalized outer layer.
A21. The separation system of paragraph A20, wherein the functionalized outer layer includes a polydimethylsiloxane outer layer.
A22. The separation system of any of paragraphs A19-A21, wherein the functionalized region includes a hydrophobic surface treatment.
A23. The separation system of paragraph A22, wherein the hydrophobic surface treatment includes at least one of a hydrophobic group, a methyl group, a hexyl group, and a benzyl group.
A24. The separation system of any of paragraphs A1-A23, wherein the filter element includes a plurality of pores configured to permit the permeate fraction of the solvent and the permeate fraction of the extract to pass therethrough.
A25. The separation system of paragraph A24, wherein the plurality of pores define a pore size, an average pore size, or an effective pore size of at least one of:
(i) a nanofiltration size range;
(ii) at least 0.5 nanometers (nm), at least 0.6 nm, at least 0.7 nm, at least 0.8 nm, at least 0.9 nm, at least 1 nm, at least 2 nm, at least 3 nm, at least 4 nm, at least 5 nm, at least 6 nm, at least 7 nm, at least 8 nm, at least 9 nm, or at least 10 nm; and
(iii) at most 20 nm, at most 18 nm, at most 16 nm, at most 14 nm, at most 12 nm, at most 10 nm, at most 9 nm, at most 8 nm, at most 7 nm, at most 6 nm, at most 5 nm, or at most 4 nm.
A26. The separation system of any of paragraphs A24-A25, wherein the plurality of pores define a/the pore size, an/the average pore size, or an/the effective pore size of at least one of:
(i) an ultrafiltration size range;
(ii) at least 10 nm, at least 15 nm, at least 20 nm, at least 30 nm, at least 40 nm, at least 50 nm, at least 60 nm, at least 70 nm, or at least 80 nm; and
(iii) at most 200 nm, at most 180 nm, at most 160 nm, at most 140 nm, at most 120 nm, at most 100 nm, at most 90 nm, at most 80 nm, at most 70 nm, at most 60 nm, at most 50 nm, at most 40 nm, at most 30 nm, or at most 20 nm.
A27. The separation system of any of paragraphs A24-A26, wherein the plurality of pores defines a size exclusion rating of at least one of:
(i) at least 100 Daltons (Da), at last 200 Da, at least 300 Da, at least
400 Da, at least 500 Da, at least 600 Da, at least 700 Da, at least 800 Da, at least 900 Da, at least 1,000 Da, at least 5,000 Da, at least 10,000 Da, at least 25,000 Da, or at least 50,000 Da for polystyrene in toluene; and
(ii) at most 100,000 Da, at most 90,000 Da, at most 70,000 Da, at most 60,000 Da, at most 50,000 Da, at most 40,000 Da, at most 30,000 Da, at most 20,000 Da, at most 10,000 Da, at most 8,000 Da, at most 6,000 Da, at most 4,000 Da, at most 2,000 Da, at most 1,000 Da, at most 900 Da, at most 800 Da, at most 700 Da, at most 600 Da, or at most 500 Da for polystyrene in toluene.
A28. The separation system of any of paragraphs A1-A27, wherein the permeate zone pressure is less than the high-pressure zone pressure.
A29. The separation system of any of paragraphs A1-A28, wherein the permeate zone pressure is greater than a permeate zone solvent vapor pressure of the solvent at the permeate zone temperature, optionally wherein the permeate zone pressure is at least a threshold permeate zone pressure differential greater than the permeate zone solvent vapor pressure, and further optionally wherein the threshold permeate zone pressure differential is at least one of:
(i) at least 5 kPa, at least 10 kPa, at least 20 kPa, at least 30 kPa, at least 40 kPa, at least 50 kPa, at least 75 kPa, at least 100 kPa, at least 150 kPa, at least 200 kPa, at least 400 kPa, at least 600 kPa, at least 800 kPa, or at least 1 MPa; and
(ii) at most 1.5 MPa, at most 1 MPa, at most 900 kPa, at most 700 kPa, at most 600 kPa, at most 500 kPa, at most 400 kPa, at most 300 kPa, at most 200 kPa, at most 100 kPa, or at most 50 kPa.
A30. The separation system of any of paragraphs A1-A29, wherein the permeate zone pressure is at least one of:
(i) at least 5 kPa, at least 10 kPa, at least 25 kPa, at least 50 kPa, at least 100 kPa, at least 150 kPa, at least 200 kPa, at least 250 kPa, at least 300 kPa, at least 350 kPa, at least 400 kPa, at least 450 kPa, at least 500 kPa, at least 1 MPa, at least 2 MPa, at least 4 MPa, at least 6 MPa, at least 8 MPa, at least 10 MPa, at least 15 MPa, or at least 20 MPa; and
(ii) at most 25 MPa, at most 20 MPa, at most 15 MPa, at most 10 MPa, at most 5 MPa, at most 1 MPa, at most 900 kPa, at most 800 kPa, at most 750 kPa, at most 700 kPa, at most 650 kPa, at most 600 kPa, at most 550 kPa, at most 500 kPa, at most 450 kPa, at most 400 kPa, at most 350 kPa, at most 300 kPa, at most 250 kPa, at most 200 kPa, at most 150 kPa, at most 100 kPa, at most 50 kPa, or at most 10 kPa.
A31. The separation system of any of paragraphs A1-A30, wherein a difference between the high-pressure zone pressure and the permeate zone pressure is at least one of:
(i) at least 4 kPa, at least 5 kPa, at least 10 kPa, at least 25 kPa, at least 50 kPa, at least 100 kPa, at least 200 kPa, at least 400 kPa, at least 600 kPa, at least 800 kPa, at least 1 MPa, at least 2 MPa, at least 3 MPa, or at least 4 MPa; and
(ii) at most 6.5 MPa, at most 6 MPa, at most 5.5 MPa, at most 5 MPa, at most 4.5 MPa, at most 4 MPa, at most 3.5 MPa, at most 3 MPa, at most 2.5 MPa, at most 2 MPa, at most 1.5 MPa, at most 1 MPa, at most 800 kPa, at most 600 kPa, at most 400 kPa, at most 200 kPa, at most 100 kPa, at most 50 kPa, at most 25 kPa, at most 10 kPa, or at most 5 kPa.
A32. The separation system of any of paragraphs A1-A31, wherein the permeate zone includes a permeate zone back flow check valve configured to permit flow of the permeate stream from the filter assembly to the permeate zone and to restrict flow of the permeate stream from the permeate zone to the filter assembly.
A33. The separation system of any of paragraphs A1-A32, wherein the permeate zone includes a permeate zone back pressure check valve configured to permit flow of the permeate stream from the filter assembly to the high-pressure zone and to restrict flow from the high-pressure zone to the permeate zone.
A34. The separation system of any of paragraphs A1-A33, wherein the separation system further includes a retentate zone configured to receive the retentate stream and to maintain the retentate stream at a retentate zone temperature and a retentate zone pressure.
A35. The separation system of paragraph A34, wherein at least one of:
(i) the retentate zone temperature is equal, or at least substantially equal, to the high-pressure zone temperature; and
(ii) the retentate zone pressure is equal, or at least substantially equal, to the high-pressure zone pressure.
A36. The separation system of any of paragraphs A1-A35, wherein the separation system further includes a recirculation zone configured to receive at least a recirculated fraction of the retentate stream, optionally from a/the retentate zone, as a recirculation stream, to maintain the recirculation stream at a recirculation zone temperature and a recirculation zone pressure, and to provide at least a fraction of the recirculation stream to the pressurization device, wherein the pressurization device is configured to pressurize the fraction of the recirculation stream to define at least a fraction of the pressurized feed stream.
A37. The separation system of paragraph A36, wherein at least one of:
(i) the recirculation zone temperature is equal, or at least substantially equal, to the feed zone temperature; and
(ii) the recirculation zone pressure is equal, or at least substantially equal, to the feed zone pressure.
A38. The separation system of any of paragraphs A1-A37, wherein the separation system further includes a retentate storage device configured to receive and store at least a stored fraction of the retentate stream.
A39. The separation system of any of paragraphs A1-A38, wherein the separation system further includes a pressure regulation system optionally configured to at least one of:
(i) maintain the feed stream at the feed zone pressure;
(ii) maintain the high-pressure zone at the high-pressure zone pressure;
(iii) maintain the permeate zone at the permeate zone pressure;
(iv) maintain a/the retentate zone at a/the retentate zone pressure; and
(v) maintain a/the recirculation zone at a/the recirculation zone pressure.
A40. The separation system of paragraph A39, wherein the pressure regulation system includes at least one pressure regulation device, and optionally wherein the at least one pressure regulation device includes at least one of:
(i) a back pressure regulator;
(ii) a pilot controlled diaphragm back pressure regulator;
(iii) an electronically pilot controlled diaphragm back pressure regulator;
(iv) an electronically controlled diaphragm back pressure regulator;
(v) a spring-type diaphragm back pressure regulator;
(vi) a piston-type diaphragm back pressure regulator;
(vii) a poppet-type back pressure regulator;
(viii) a needle valve;
(ix) a fixed orifice; and
(x) a check valve with a predetermined break pressure.
A41. The separation system of any of paragraphs A1-A40, wherein at least one of the permeate zone and a/the pressure regulation system includes a permeate zone pressure regulation device configured to maintain the permeate zone at the permeate zone pressure.
A42. The separation system of paragraph A41, wherein the permeate zone pressure regulation device includes at least one of a back pressure regulator, a pilot controlled diaphragm back pressure regulator, an electronically pilot controlled diaphragm back pressure regulator, an electronically controlled diaphragm back pressure regulator, a spring-type diaphragm back pressure regulator, a piston-type diaphragm back pressure regulator, a poppet-type back pressure regulator, a needle valve, a fixed orifice, and a check valve with a predetermined break pressure.
A43. The separation system of any of paragraphs A41-A42, wherein the permeate zone pressure regulation device at least one of:
(i) is positioned between the permeate zone and a system component that is downstream from the permeate zone; and
(ii) fluidically separates the permeate zone from the system component that is downstream from the permeate zone.
A44. The separation system of any of paragraphs A1-A43, wherein at least one of the permeate zone and a/the pressure regulation system includes a pressurized gas source configured to provide a pressurized gas stream to at least one other component of the separation system to maintain a corresponding component pressure.
A45. The separation system of paragraph A44, wherein the corresponding component pressure includes, or is, at least one, and optionally both, of:
(i) the permeate zone pressure; and
(ii) the feed zone pressure.
A46. The separation system of any of paragraphs A1-A45, wherein the separation system further includes a temperature regulation system configured to at least one of:
(i) maintain the feed stream at the feed zone temperature;
(ii) maintain the high-pressure zone at the high-pressure zone temperature;
(iii) maintain the permeate zone at the permeate zone temperature;
(iv) maintain a/the retentate zone at a/the retentate zone temperature; and
(v) maintain a/the recirculation zone at a/the recirculation zone temperature.
A47. The separation system of paragraph A46, wherein the temperature regulation system includes at least one of:
(i) thermal insulation;
(ii) a temperature control device;
(iii) an active temperature control device;
(iv) a passive temperature control device;
(v) a heater; and
(vi) a cooler.
A48. The separation system of any of paragraphs A1-A47, wherein the separation system includes the feed stream.
A49. The separation system of any of paragraphs A1-A48, wherein the extract is generated utilizing a closed-loop extraction process.
A50. The separation system of any of paragraphs A1-A49, wherein the extract defines a plurality of micelles suspended within an extraction solvent.
A51. The separation system of any of paragraphs A1-A50, wherein the extract includes at least one of a cannabis extract, cannabinoids, tetrahydrocannabinol (THC), cannabidiol (CBD), tetrahydrocannabinolic acid (THCA), cannabidiolic acid (CBDA), cannabichromenic acid (CBCA), cannabinoid acids, cannabitriol, cannabielsoin, a wax, a fat, a fatty acid, an ester, a color body, a pigment, chlorophyll, an oxidative degradation product of chlorophyll, and a terpene.
A52. The separation system of any of paragraphs A1-A51, wherein at least one of:
(i) a solvent vapor pressure of the solvent is greater than 101.3 kPa at 0° C.; and
(ii) the solvent is in the solvent gas phase at 101.3 kPa and 0° C.
A53. The separation system of any of paragraphs A1-A52, wherein the solvent includes, or is, at least one of an organic solvent, a hydrocarbon solvent, an aliphatic hydrocarbon solvent, methane, ethane, propane, butane, n-butane, isobutane, and a fluorocarbon.
A54. The separation system of any of paragraphs A1-A53, wherein the solvent includes, or is, a gas expanded liquid solvent.
A55. The separation system of any of paragraphs A1-A54, wherein the solvent includes a gaseous additive, optionally wherein the solvent includes at most 25 weight percentage (wt %) of the gaseous additive, and further optionally wherein the gaseous additive includes at least one of carbon dioxide, nitrogen, hydrogen, helium, argon, xenon, and nitrous oxide.
A56. The separation system of any of paragraphs A1-A55, wherein the separation system further includes a closed-loop extraction device configured to separate the extract from at least one component and to provide the extract to the feed zone within the feed stream.
A57. The separation system of any of paragraphs A1-A56, wherein the separation system further includes a permeate distillation device, or a permeate distillation column, configured to receive the permeate stream and to at least partially separate at least one component of the permeate fraction of the extract from the permeate fraction of the solvent.
A58. The separation system of any of paragraphs A1-A57, wherein the separation system further includes a retentate distillation device, or a retentate distillation column, configured to receive the retentate stream and to at least partially separate at least one component of the retentate fraction of the extract from the retentate fraction of the solvent.
B1. A method of separating components of an extract suspended within a solvent utilizing the separation system of any of paragraphs A1-A58, the method comprising:
providing the feed stream to the feed zone and maintaining the feed stream at the feed zone temperature and the feed zone pressure within the feed zone;
receiving the feed stream with the pressurization device and utilizing the pressurization device to pressurize the feed stream and define the pressurized feed stream;
receiving the pressurized feed stream from the pressurization device and into the high-pressure zone and maintaining the pressurized feed stream at the high-pressure zone temperature and the high-pressure zone pressure within the high-pressure zone;
receiving the pressurized feed stream from the high-pressure zone and into the filter assembly;
separating the pressurized feed stream with the filter element to produce the permeate stream and the retentate stream; and
receiving the permeate stream from the filter assembly and into the permeate zone and maintaining the permeate stream at the permeate zone temperature and the permeate zone pressure within the permeate zone.
B2. The method of paragraph B1, wherein the method further includes recirculating at least a/the recirculated fraction of the retentate stream to the pressurization device and pressurizing the recirculated fraction of the retentate stream with the pressurization device to define at least a/the fraction of the pressurized feed stream, optionally wherein the recirculating includes recirculating from a/the retentate zone of the separation system, and further optionally wherein the recirculating includes recirculating at least partially via a/the recirculation zone of the separation system.
B3. The method of paragraph B2, wherein the recirculating includes continuously recirculating the at least the recirculated fraction of the retentate stream for at least a threshold recirculation time.
B4. The method of any of paragraphs B1-B3, wherein the extract includes a/the cannabis extract that includes cannabinoids.
B5. The method of paragraph B4, wherein the method includes at least one of dewaxing and decoloring the cannabis extract, and further wherein, during the at least one of dewaxing and decoloring:
(i) the retentate stream includes at least a majority fraction of compounds within the cannabis extract that are larger than the cannabinoids; and
(ii) the permeate stream includes at least a majority fraction of the cannabinoids and also at least a majority fraction of compounds within the cannabis extract that are smaller than the cannabinoids.
B6. The method of paragraph B5, wherein at least one of:
(i) the compounds within the cannabis extract that are larger than the cannabinoids include at least one of lipids, waxes, fats, fatty acids, esters, color bodies, pigments, chlorophyll, and oxidative degradation products of chlorophyll; and
(ii) the compounds within the cannabis extract that are smaller than the cannabinoids include terpenes.
B7. The method of paragraph B4, wherein the method includes separating terpenes from the cannabinoids within the cannabis extract, and further wherein, during the separating terpenes:
(i) the retentate stream includes at least a majority fraction of the cannabinoids; and
(ii) the permeate stream includes at least a majority fraction of the terpenes and other components that are smaller than the cannabinoids.
B8. The method of paragraph B4, wherein the method includes purifying the solvent, and further wherein, during the purifying the solvent:
(i) the retentate stream includes at least a majority fraction, such as at least 60 wt %, at least 70 wt %, at least 80 wt %, or at least 90 wt %, of components of the extract from the feed stream; and
(ii) the permeate stream includes at least a majority fraction, such as at least 60 wt %, at least 70 wt %, at least 80 wt %, or at least 90 wt %, of the solvent from the feed stream.
B9. The method of paragraph B8, wherein the method includes purifying the solvent without distilling the feed stream.
B10. A method of purifying a cannabis extract that includes cannabinoids, the method comprising:
providing a feed stream that includes the cannabis extract suspended within a solvent;
performing a first separation by performing one of:
(i) the method of any of paragraphs B5-B6 on the feed stream to dewax and decolor the cannabis extract; and
(ii) the method of paragraph B7 on the feed stream to separate terpenes from the cannabis extract;
wherein, during the first separation, the retentate stream is a first retentate stream and the permeate stream is a first permeate stream; and
subsequently performing a second separation by performing the other of:
(i) the method of any of paragraphs B5-B6 utilizing the first retentate stream as the feed stream to dewax and decolor the cannabis extract; and
(ii) the method of paragraph B7 utilizing the first permeate stream as the feed stream to separate terpenes from the cannabis extract;
wherein, during the second separation, the retentate stream is a second retentate stream and the permeate stream is a second permeate stream.
B11. The method of paragraph B10, wherein, during the performing the first separation, the filter element is a first filter element, and further wherein, prior to the performing the second separation, the method includes replacing the first filter element with a second filter element that differs from the first filter element, optionally wherein one of:
(i) when the first separation includes performing the method of any of paragraphs B5-B6 on the feed stream to dewax and decolor the cannabis extract, a first pore size, or an average first pore size, of the first filter element is greater than a second pore size, or an average second pore size, of the second filter element; and
(ii) when the first separation includes performing the method of paragraph B7 on the feed stream to separate terpenes from the cannabis extract, the first pore size, or the average first pore size, of the first filter element is less than the second pore size, or the average second pore size, of the second filter element.
B12. The method of any of paragraphs B10-B11, wherein the providing the feed stream includes performing a closed-loop extraction process to separate the cannabis extract from at least one component of a cannabis plant.
B13. The method of any of paragraphs B10-B12, wherein, one of:
(i) prior to performing the first separation, the method further includes performing a preliminary separation by performing the method of any of paragraphs B8-B9 on the feed stream to separate solvent from the feed stream, wherein, during the initial separation, the retentate stream is an initial retentate stream and the permeate stream is an initial permeate stream, and further wherein the performing the first separation includes performing the first separation utilizing the initial retentate stream as the feed stream;
(ii) subsequent to performing the first separation and prior to performing the second separation, the method further includes performing an intermediate separation by performing the method of any of paragraphs B8-B9 utilizing the first retentate stream as the feed stream to separate solvent from the first retentate stream, wherein, during the intermediate separation, the retentate stream is an intermediate retentate stream and the permeate stream is an intermediate permeate stream, and further wherein the performing the second separation includes performing the second separation utilizing the intermediate retentate stream as the feed stream;
(iii) subsequent to performing the first separation and prior to performing the second separation, the method further includes performing an intermediate separation by performing the method of any of paragraphs B8-B9 utilizing the first permeate stream as the feed stream to separate solvent from the first permeate stream, wherein, during the intermediate separation, the retentate stream is an intermediate retentate stream and the permeate stream is an intermediate permeate stream, and further wherein the performing the second separation includes performing the second separation utilizing the intermediate retentate stream as the feed stream; and
(iv) subsequent to performing the second separation, the method further includes performing a third separation by performing the method of any of paragraphs B8-B9 utilizing the second permeate stream as the feed stream to separate solvent from the second permeate stream, wherein the retentate stream is a third retentate stream, and further wherein the permeate stream is a third permeate stream.
B14. The method of paragraph B13, wherein the method further includes repeating the method and re-using one of the initial permeate stream, the intermediate permeate stream, and the third permeate stream as the solvent.
B15. The method of any of paragraphs B10-B14, wherein, subsequent to the performing the second separation, the method further includes distilling the second retentate stream to concentrate the cannabinoids and define a cannabinoid product stream.

### INDUSTRIAL APPLICABILITY

The systems and methods disclosed herein are applicable to the extract, botanical extract, fungal extract, animal product extract, dietary supplement, pharmaceutical, cosmetic, and cannabis industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A separation system for separating components of an extract suspended within a solvent, wherein the extract includes at least one of a botanical extract, a fungal extract, and an animal product extract, wherein the solvent is in a solvent gas phase at standard temperature and pressure, and further wherein the separation system is configured to maintain the solvent in at least one of a solvent liquid phase and a solvent supercritical phase, the separation system comprising:
a feed zone configured to receive a feed stream that includes the extract suspended within the solvent and to maintain the feed stream at a feed zone temperature and a feed zone pressure;
a pressurization device configured to pressurize the feed stream to define a pressurized feed stream;
a high-pressure zone configured to receive the pressurized feed stream and to maintain the pressurized feed stream at a high-pressure zone temperature and a high-pressure zone pressure;
a filter assembly that includes a filter element configured to receive the pressurized feed stream and to separate the pressurized feed stream into a permeate stream, which includes a permeate fraction of the solvent and a permeate fraction of the extract that passes through the filter element, and a retentate stream, which includes a retentate fraction of the solvent and a retentate fraction of the extract that that does not pass through the filter element; and
a permeate zone configured to receive the permeate stream from the filter assembly and to maintain the permeate stream at least one of at a permeate zone temperature and at a permeate zone pressure.

2. The separation system of claim 1, wherein the permeate zone includes a permeate zone pressure regulation device configured to maintain the permeate zone at the permeate zone pressure, wherein the permeate zone pressure regulation device includes at least one of a back pressure regulator, a pilot controlled diaphragm back pressure regulator, an electronically pilot controlled diaphragm back pressure regulator, an electronically controlled diaphragm back pressure regulator, a spring-type diaphragm back pressure regulator, a piston-type diaphragm back pressure regulator, a poppet-type back pressure regulator, a needle valve, a fixed orifice, and a check valve with a predetermined break pressure.

3. The separation system of claim 2, wherein the permeate zone pressure regulation device at least one of:
(i) is positioned between the permeate zone and a system component that is downstream from the permeate zone; and
(ii) fluidically separates the permeate zone from the system component that is downstream from the permeate zone.

4. The separation system of claim 1, wherein the separation system includes a pressure regulation system, wherein the pressure regulation system includes a pressurized gas source configured to provide a pressurized gas stream to at least one other component of the separation system to maintain a corresponding component pressure.

5. The separation system of claim 4, wherein the corresponding component pressure includes the permeate zone pressure.

6. The separation system of claim 4, wherein the corresponding component pressure includes the feed zone pressure.

7. The separation system of claim 1, wherein:
(i) the feed zone pressure is greater than a feed zone solvent vapor pressure of the solvent at the feed zone temperature;
(ii) the high-pressure zone pressure is greater than a high-pressure zone solvent vapor pressure of the solvent at the high-pressure zone temperature; and(iii) the permeate zone pressure is greater than a permeate zone solvent vapor pressure of the solvent at the permeate zone temperature.

8. The separation system of claim 1, wherein the pressurization device is configured to generate a pressurization device pressure differential between the feed stream and the pressurized feed stream that is at least as large as a pressure differential between the high-pressure zone pressure and the feed zone pressure, wherein the pressurization device pressure differential is at least one of at least 5 kPa and at most 7 MPa.

9. The separation system of claim 1, wherein the filter assembly is a pressure-driven filter assembly configured to separate the pressurized feed stream into the permeate stream and the retentate stream responsive to a difference between the high-pressure zone pressure and the permeate zone pressure.

10. The separation system of claim 1, wherein the filter element includes a membrane filter element that includes at least one filtration membrane.

11. The separation system of claim 10, wherein the membrane filter element includes at least one of a tangential flow filtration element, a nanofiltration element, and an ultrafiltration element.

12. The separation system of claim 10, wherein the at least one filtration membrane includes at least one of:
(i) a polydimethylsiloxane outer layer supported by a polyacrylonitrile support layer;
(ii) a polyimide outer layer supported by a polyacrylonitrile support layer;
(iii) a silicone outer layer supported by a polyimide support layer;
(iv) a graphene oxide outer layer supported by a polyvinylidene fluoride support layer;
(v) a nanoporous polyvinylidene fluoride filtration membrane;
(vi) a titanium oxide filtration membrane;
(vii) a functionalized titanium oxide filtration membrane;
(viii) a zirconium oxide filtration membrane;
(ix) a functionalized zirconium oxide filtration membrane; and
(x) an organic solvent nanofiltration membrane.

13. The separation system of claim 10, wherein the at least one filtration membrane includes a ceramic filtration membrane.

14. The separation system of claim 13, wherein the ceramic filtration membrane is a functionalized ceramic filtration membrane that includes a functionalized region.

15. The separation system of claim 14, wherein the functionalized region includes a functionalized outer layer, and further wherein the functionalized outer layer includes a polydimethylsiloxane outer layer.

16. The separation system of claim 14, wherein the functionalized region includes a hydrophobic surface treatment, and further wherein the hydrophobic surface treatment includes at least one of a hydrophobic group, a methyl group, a hexyl group, and a benzyl group.

17. The separation system of claim 1, wherein the filter element includes a plurality of pores configured to permit the permeate fraction of the solvent and the permeate fraction of the extract to pass therethrough, and further wherein the plurality of pores defines an average pore size at least one of:
(i) in a nanofiltration size range; and
(ii) of at least 0.5 nanometers (nm) and at most 20 nm.

18. The separation system of claim 1, wherein the filter element includes a plurality of pores configured to permit the permeate fraction of the solvent and the permeate fraction of the extract to pass therethrough, and further wherein the plurality of pores defines an average pore size at least one of:
(i) in an ultrafiltration size range; and
(ii) of at least 10 nm and at most 200 nm.

19. The separation system of claim 1, wherein the separation system includes the feed stream, wherein the extract defines a plurality of micelles suspended within an extraction solvent, and further wherein the extract includes at least one of a cannabis extract, cannabinoids, tetrahydrocannabinol (THC), cannabidiol (CBD), tetrahydrocannabinolic acid (THCA), cannabidiolic acid (CBDA), cannabichromenic acid (CBCA), cannabinoid acids, cannabitriol, cannabielsoin, a wax, a fat, a fatty acid, an ester, a color body, a pigment, chlorophyll, an oxidative degradation product of chlorophyll, and a terpene.

20. A method of separating components of an extract suspended within a solvent utilizing the separation system of claim 1, the method comprising:
providing the feed stream to the feed zone and maintaining the feed stream at the feed zone temperature and the feed zone pressure within the feed zone;
receiving the feed stream with the pressurization device and utilizing the pressurization device to pressurize the feed stream and define the pressurized feed stream;
receiving the pressurized feed stream from the pressurization device and into the high-pressure zone and maintaining the pressurized feed stream at the high-pressure zone temperature and the high-pressure zone pressure within the high-pressure zone;
receiving the pressurized feed stream from the high-pressure zone and into the filter assembly;
separating the pressurized feed stream with the filter element to produce the permeate stream and the retentate stream; and
receiving the permeate stream from the filter assembly and into the permeate zone and maintaining the permeate stream at the permeate zone temperature and the permeate zone pressure within the permeate zone.
